(19) United States
(12) Patent Application Publication
(10) Pub. No.: US 2009/0165343 A1
(43) Pub. Date: Jul. 2, 2009

(54) Providing Supplemental Content for a Social Expression Product

(75) Inventors: Carol Miller, Twinsburg, OH (US); Harry West, Lexington, MA (US); Kenneth Ryan Gilroy, Copley, OH (US); Masanao Homma, Westlake, OH (US); Toby Shingleton, Euclid, OH (US)

Correspondence Address: KING & SPALDING, 1180 PEACHTREE STREET , NE, ATLANTA, GA, 30309-3521, US

(73) Assignee: American Greetings Corporation, Cleveland, OH (US)

(21) Appl. No.: 12/407,090

(22) Filed: Mar. 19, 2009

Related U.S. Application Data
(63) Continuation of application No. 12/001,098, filed on Dec. 10, 2007.
(60) Provisional application No. 60/873,821, filed on Dec. 8, 2006.
(60) Provisional application No. 60/937,902, filed on Jun. 29, 2007.
(60) Provisional application No. 60/925,632, filed on Apr. 20, 2007.

(51) Int. Cl. G09F 1/04

(52) U.S. Cl. 40/124.06

(57) ABSTRACT

Providing a digital experience with a greeting card. A card purchaser selects one or more digital experiences to enhance or complete the thought of the selected card. The selection of digital experiences can occur using a computing device in a retail store or remotely via the Internet. The purchaser scans an identification code or selects a digital representation of the greeting card at the computing device and is presented with digital experiences best suited to the selected card. Additionally, the card purchaser may view or select from a full-line of digital experiences without scanning or selecting the digital representation of the card. Information relating to the digital experience is included in the card. The card is transmitted to a recipient, and the recipient accesses the digital experience based on information provided in the greeting card. The digital experience may be provided to the recipient using a digital delivery device.

### STATEMENT OF RELATED PATENT APPLICATIONS

This application is a continuation of U.S. patent application Ser. No. 12/001,098, entitled, “Method, System, and Apparatus for Providing Supplemental Content for a Social Expression Product,” filed Dec. 10, 2007, the complete disclosure of which is hereby fully incorporated herein by reference.

### FIELD OF THE INVENTION

This invention relates to the enhancement of social expression products with standard, digital, or online format. More specifically, the invention provides method and apparatus to enhance social expression products with digital content and supplemental mediums.

### BACKGROUND OF THE INVENTION

Social expression products are conventionally grouped together and sold at a retail location. Social expression products include, but are not limited to, greeting cards, gift bags, wrapping paper, boxed card sets, party paper goods (including hats, plates, napkins and blowouts that contain popular characters or designs), calendars, and gift tags. For certain types of social expression products, such as greeting cards, a consumer typically purchases the social expression product, adds additional written information, and transmits the social expression product to a recipient. Social expression products may contain an expression of a thought comprising written text, artwork, designs and/or themes (i.e., copy) that are imprinted on the product by the manufacturer of the product. However, with conventional social expression products, the expression of the thought does not extend past the social expression product itself. Because of this, the expression of the thought is not enhanced or completed outside the information imprinted or written on the social expression product. Further, with conventional social expression products, a purchaser is not provided with digital content to enhance the expression of the thought found in the social expression product that is transmitted to the card recipient.

Similarly, with other types of social expression products, such as wrapping paper, party plates, and gift bags, the expression of the thought is conventionally limited to the product itself and any written expression added by a purchaser. Therefore, other types of social expression products also beyond greeting cards are limited by the imprinted or written information contained on the product.

Accordingly, there exists a need in the art for supplementing a social expression product in order to enhance an expression of a thought contained in the social expression product. Furthermore, there exists a need in the art for previewing, selecting, and associating the supplemental content for the social expression product either at the retail location or at a remote location.

### SUMMARY OF THE INVENTION

The present invention enhances an expression of a thought in a social expression product by supplementing the social expression product with a digital experience, lottery ticket, or gift certificate. An expression of a thought may comprise a sentiment contained in written text, artwork, designs and/or themes imprinted on the social expression product. Such thoughts may include, but are not limited to, sentiments such as “Happy Birthday,” “I'm Sorry,” “Congratulations,” “Best Wishes,” “Get Well Soon,” “Thinking of You,” “I Love You,” “Merry Christmas,” and “Happy Hanukkah.”

The social expression product may be displayed in a display area of a retail location. A portion of the social expression products may comprise a URL, a digital delivery device, a lottery ticket, or a gift certificate that has a characteristic or theme in common with the social expression product. A digital delivery device may include, but is not limited to, a Universal Serial Bus (“USB”) flash drive, a Liquid Crystal Display (“LCD”) screen, a memory card, a Compact Disc (“CD”), and a Digital Versatile Disc (“DVD”).

The URL and digital delivery device can provide a recipient with access to a digital experience, which enhances the expression of a thought that is found in the social expression product. The digital experience may relate to entertainment, information, keepsakes, gifts, or tools that can be accessed by the recipient, and may include, but is not limited to, a photo, a video, a joke, a quiz, a game, a horoscope, information about the artist of the social expression product, information about the subject of the social expression product, a published article, a recorded voice message, and a customized story. The digital experience may comprise a common theme or characteristic with the social expression product and may be individualized by the consumer to enhance the expression of the thought in the social expression product. Further, the digital experience may be customized (at a retail location or remotely) by a purchaser. For example, a purchaser may choose to scan a greeting card at a retail location and add the recipients name to a digital experience that can be associated with the greeting card using a computing device. Similarly, a purchaser may select a digital experience at a remote location using a website provided by a third-party, and the purchaser may customize the digital experience by adding information such as audio and/or video to the digital experience.

The social expression product may likewise be associated with a supplemental medium, such as a lottery ticket, gift card, or digital delivery device. The supplemental medium may be imprinted with a theme or characteristic that enhances an expression of a thought in the social expression product. Characteristics may include, but are not limited to, art, color, wording, or other copy-related features of a social expression product. Further, a digital delivery device may comprise a digital experience that enhances the expression of the thought in the social expression product.

In an exemplary embodiment, greeting cards are displayed at a retail location with at least a portion of the greeting cards containing a URL for accessing a digital experience. A potential purchaser can review the digital experience associated with the greeting card by utilizing a scanner and computing device located within close proximity to the greeting card display. The potential purchaser scans an identification code located on the greeting card (or alternatively selects the product using a screen coupled to the computer). A screen connected to the computer displays the digital experience associated with the greeting card. In an exemplary embodiment, the recipient of the card may be provided a password to access the website containing the digital experience and may be limited to the number of times she can access the digital experience.

In an alternative or additional embodiment, a digital experience is provided with a greeting card through the use of a digital delivery device. The digital delivery device may be associated with the greeting card prior to the purchase of the greeting card (i.e., the two items are pre-packaged) or a purchaser may select the digital delivery device that best complements a selected greeting card. The digital delivery device may comprise characteristics or a theme in copy with the greeting card. The digital experience may be pre-loaded on the digital delivery device or may be loaded at a later time.

Similarly, in another embodiment, a gift card and/or lottery ticket may be associated with a greeting card to enhance the expression of a thought contained in the greeting card. In an exemplary embodiment, the greeting card and/or lottery ticket comprises a theme and/or characteristics in common with the greeting card. The lottery ticket and/or greeting card may be displayed in a retail location in close proximity to a greeting card display. Further, in an alternative embodiment, the gift card and/or lottery ticket may be pre-packaged or combined with the greeting card.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a block diagram illustrating an exemplary operating environment for implementation of various embodiments of the present invention;

FIG. 2 is a functional logic diagram illustrating an operating environment for a computing device, according to an exemplary embodiment of the present invention;

FIG. 3 is a flowchart illustrating a process for selecting a digital delivery device, according to an exemplary embodiment of the present invention;

FIG. 4 is a flowchart illustrating a process for selecting and associating a digital experience with a greeting card, according to an exemplary embodiment of the present invention;

FIG. 5 is a flowchart illustrating a process for showing a presentation of a digital experience at a retail location, according to an exemplary embodiment of the present invention;

FIG. 6 is a flowchart illustrating a process for selecting a greeting card and digital experience and presenting the card and digital experience to the card recipient in accordance with another exemplary embodiment of the present invention;

FIG. 7 is a flowchart illustrating an alternative process for selecting a greeting card and digital experience and presenting the card and digital experience to the card recipient in accordance with another exemplary embodiment of the present invention;

FIG. 8 is a flowchart illustrating another alternative process for selecting a greeting card and digital experience and presenting the card and digital experience to the card recipient in accordance with another exemplary embodiment of the present invention;

FIG. 9 is a flowchart illustrating another alternative process for selecting a greeting card and digital experience and presenting the card and digital experience to the card recipient in accordance with another exemplary embodiment of the present invention;

FIG. 10 is a flowchart illustrating another alternative process for selecting a greeting card and digital experience presenting the card and digital delivery device to the card recipient in accordance with another exemplary embodiment of the present invention;

FIG. 11 is a flowchart illustrating another alternative process for selecting a greeting card and digital delivery device and presenting the card and digital delivery device to the card recipient in accordance with another exemplary embodiment of the present invention;

FIG. 12 is a flowchart illustrating another alternative process for selecting a greeting card and digital experience presenting the card and digital delivery device to the card recipient in accordance with another exemplary embodiment of the present invention

FIGS. 13-22 are representative embodiments for associating a digital delivery device with a social expression product in accordance with several exemplary embodiments of the present invention;

FIGS. 23a-b, 24a-c, and 25-26 illustrate exemplary greeting cards and associated digital experiences, according to several exemplary embodiment of the present invention;

FIGS. 27-31 illustrate exemplary embodiments for associating and securing a gift card or lottery ticket with a greeting card, according to several exemplary embodiment of the present invention;

FIG. 32 illustrates a greeting card with a device to assist in scratching off the scratch-off portion of lottery tickets, according to an exemplary embodiment;

FIG. 33 illustrates a system for displaying greeting cards adjacent supplemental mediums, according to an exemplary embodiment of the present invention;

FIG. 34 illustrates a system for displaying greeting cards adjacent to a holding system, according to an exemplary embodiment of the present invention;

FIG. 35 illustrates a system for displaying combination greeting card gift cards, according to an exemplary embodiment of the present invention; and

FIG. 36 illustrates a method for selecting and utilizing greeting card gift cards, according to an exemplary embodiment of the present invention.

### DETAILED DESCRIPTION OF THE EXEMPLARY EMBODIMENTS

The present invention includes methods, systems, and apparatus for providing supplemental content to enhance the thought of a social expression product. Social expression products may include, but are not limited to, greeting cards, gift bags, wrapping paper, boxed card sets, party paper goods (including hats, plates, napkins and blowouts that contain popular characters or designs), calendars, and gift tags. A digital experience may be provided to enhance the thought or meaningful connection of the social expression product. In addition, lottery tickets or gift cards may be provided to enhance the thought or meaningful connection of the social expression product. In addition, the present invention includes methods and apparatus for providing secure placement of a supplemental medium, such as a digital delivery device, lottery ticket (or similar games of chance), or gift card within a social expression product. The present invention also includes methods and apparatus for marketing social expression products adjacent to digital delivery devices, lottery tickets (or similar games of chance), or gift cards. In addition, the present invention includes methods for remotely purchasing a conventional social expression product and lottery ticket or gift card, personalizing the social expression product, and having the social expression product and lottery ticket or gift card associated with one another and sent to a card recipient. In addition, the present invention includes methods and apparatus for purchasing a social expression product and supplemental medium (e.g., digital delivery device, lottery ticket, and gift card) at a retail location and applying the art of the social expression product to the supplemental medium based on an evaluation of the themes or characteristics of the social expression product. Further, the present invention includes methods and apparatus for purchasing a combined social expression product and gift card and selecting the amount of the gift card after selection of the combined product.

It should be understood that references to lottery tickets should not be limited to lottery tickets, but may further include promotions for lottery tickets, other games of chance, gift certificates, gift cards, coupons for lottery tickets, coupons for gift certificates and gift cards, or coupons for other items that may be incorporated with social expression products. Further, promotions for lottery tickets may include discounts—such as buying a certain number of lottery tickets and getting a certain number of lottery tickets free, inclusion in specialized drawings, being provided the opportunity to buy tickets specifically geared to a promotion related to the purchase of the social expression product or other gift card, and lottery ticket promotions known to those or ordinary skill in the art. For ease of reference, lottery tickets, promotions for a lottery ticket, gift cards, and gift certificates will hereinafter be described with reference to lottery tickets. Furthermore, the lottery tickets described herein include, but are not limited to, scratch-off tickets, daily drawing tickets, lottery tickets provided on the local, state, and/or national level, and multi-day and multi-state lottery games, such as POWERBALL and equivalents thereof.

According to an exemplary embodiment of the present invention, a social expression product may be supplemented with a digital experience. The digital experience may take several forms. Examples of a digital experience include, but are not limited to, a photo, a video, a joke, a quiz, a game, a horoscope, information about the artist of the social expression product, information about the subject of the social expression product, a published article, a recorded voice message, and a customized story. Moreover, Table 1 below provides a non-exhaustive listing of additional exemplary digital experiences that may be used to enhance the expression of the thought of the social expression product.

TABLE 1
Exemplary Digital Experiences

| Entertainment | Information | Keepsakes | Gifts | Tools |
|---|---|---|---|---|
| Video | About the artist | Photo | Art | Scheduling |
| Animation | About the | Photo album | Screensaver | calendar |
| Game | subject of the | Photo | Desktop | RSVP |
| (e.g., puzzle) | social expression | slideshow | wallpaper | management |
| Joke | product | Home video | Music | Poll/Feedback |
| Quiz | Interest article | Customized | (e.g., song) | Printable cards |
| Polling | Horoscope | story | Playlist | Printable |
| Blog site | Sports | Recorded voice | (e.g., list of | expression |
| Horoscope | highlight | message | multiple songs) | |
| Adult | Celebrity | | Loyalty points | |
| entertainment | gossip | | IOU | |
| Digital lottery | Invitation | | Recipe | |
| ticket | details | | Prayer | |
| | Podcast | | Inspirational | |
| | Movie | | message | |
| | schedule | | Avatar (e.g., | |
| | | | buddy icon) | |
| | | | Ringtone | |
| | | | Gift card (e.g., | |
| | | | retailer, credit | |
| | | | card, and phone) | |
| | | | Magazine | |
| | | | subscription | |
| | | | Movie ticket | |

The digital experience may be provided by way of access to a URL that is associated with the social expression product. Additionally, a social expression product may be supplemented with a digital delivery device that comprises a digital experience. Examples of a digital delivery device include, but are not limited to, Universal Serial Bus (“USB”) flash drive, Liquid Crystal Display (“LCD”) screen, memory card, Compact Disc (“CD”), and Digital Versatile Disc (“DVD”). Further, a digital delivery device may comprise a computing function as its digital experience. One example of a computing function (i.e., a digital experience) which can be launched or otherwise enabled by digital content on a digital delivery device is connection to an application for building or modifying a website. The digital delivery device may contain a hyperlink to a site which presents a template to the user for composing one or more website pages. Additional data content such as photos or graphics or text for the pages may be contained on the digital delivery device, or acquired from elsewhere.

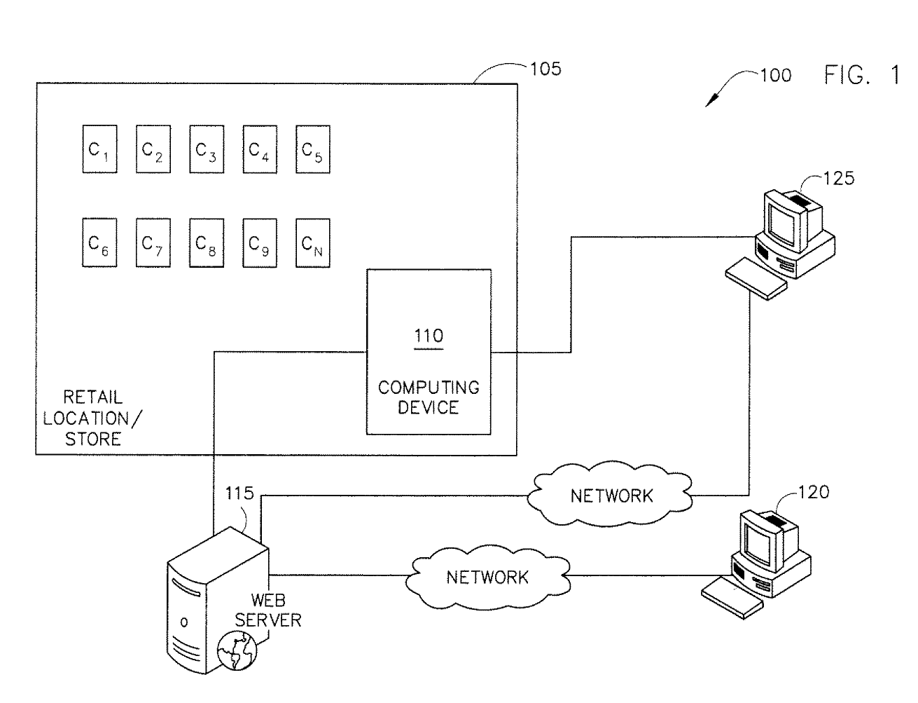

Referring now to the drawings, in which like numerals represent like elements throughout the several figures, aspects of the present invention and an exemplary operating environment will be described in the context of FIGS. 1 through 12.

FIG. 1 is a block diagram illustrating a digital experience system 100 constructed in accordance with one exemplary embodiment of the present invention. The exemplary retail card and digital experience system (hereinafter “digital experience system”) 100 includes a conventional “brick and mortar” retail store/location 105, a web server 115, a card purchaser computer 120, and a recipient computer 125.

The retail store 105 includes one or more conventional greeting cards C₁-C_{N} that can be purchased by consumers. In one exemplary embodiment, the greeting cards C₁-C_{N} are presented in a display rack having multiple rows and columns for viewing and selecting a greeting card. It is noted that, while the exemplary embodiments describe the association of supplemental content with greeting cards, greeting cards are used for illustrative purposes only, and any other social expression products may be utilized with the present invention, including, but not limited to, wrapping paper, boxed card sets, party paper goods (including hats, plates, napkins and blowouts that contain popular characters or designs), calendars, and gift tags.

The retail store 105 can also include a kiosk or computing device 110 for previewing digital experiences. An exemplary computing device 110 may or may not be freestanding. For example, in one exemplary embodiment, the computing device 110 may be incorporated into the greeting card display. However, those of ordinary skill in the art will recognize that the computing device 110 can also be free-standing, attached to another portion of the greeting card display, or attached to another fixture within the retail store 105. The computing device 110 may be communicably attached to a web server 115 where digital experiences may be stored and maintained. Alternatively, the computing device 110 may not be connected to a web server 115, but may instead include memory for storing, displaying, and providing digital experiences.

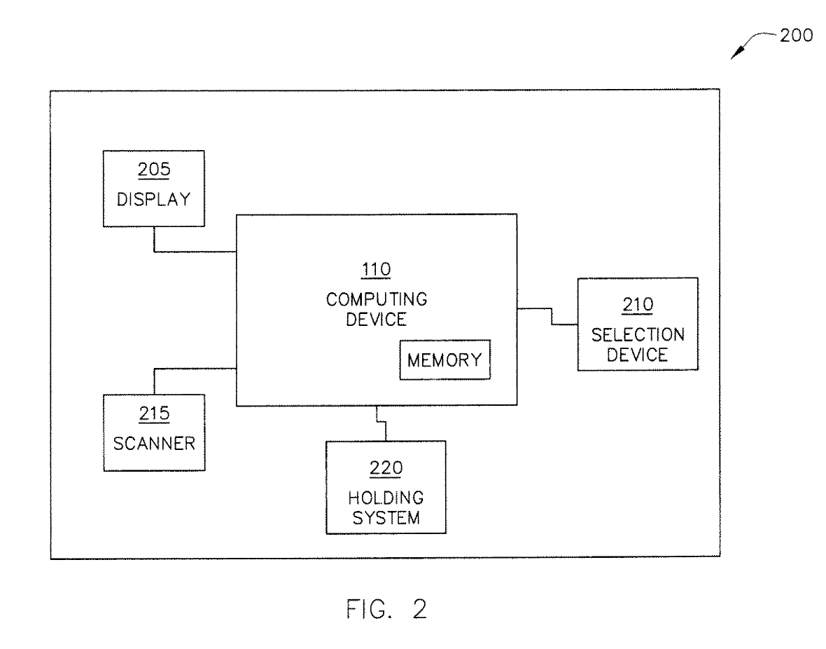

An exemplary operating environment 200 for the computing device is illustrated in FIG. 2. As illustrated, the computing device 110 can be communicably connected to a display 205, such as a standard screen, touch-screen display system, plasma screen, or Liquid Crystal Display (“LCD”). Further, the computing device 110 may also be communicably connected to one or more selection devices 210, including, but not limited to, a mouse, a touchpad, thumbwheels, and buttons. Further, the computing device 110 may be communicably connected to a scanner 215. It is noted that, while the computing device 110 is shown connected to the various peripherals in FIG. 2, one of ordinary skill in the art knows that the computing device may comprise one or more of the components illustrated in FIG. 2, as might be the case when a kiosk is utilized with the present invention.

According to an exemplary embodiment, the computing device 110 can include more than one type of selection devices 210 for use with the computing device 110, each generating a different effect on the content being presented on the display 205. Further, the display 205 may be capable of presenting full-motion video to a viewer.

The computing device 110 may provide access to digital content comprising the digital experience stored internally in the computing device 110 (i.e., in memory in the computing device), at memory located elsewhere in the retail store 105, or accessible through the web server 115. Examples of digital content that may comprise the digital experience include, but are not limited to, MPEG-1 Audio Layer 3 (“MP3”), MPEG-1, MPEG-2, Waveform audio format (“WAV”), MPEG-4, MPEG-4 Part 14 (“MP4”), Windows Media Audio (“WMA”), and Advanced Audio Coding (“AAC”).

The computing device 110 can also provide access to a digital delivery device by being communicably connected to a digital delivery device holding system 220, such as a vending machine, for dispensing digital delivery devices. As used in this application, a digital delivery device may comprise, but is not limited to, a Universal Serial Bus (“USB”) flash drive, Liquid Crystal Display (“LCD”) screen, memory card, Compact Disc (“CD”), and Digital Versatile Disc (“DVD”), as well as other digital delivery devices. Each of the digital delivery devices may include and be used to access a digital experience. For example, a USB flash drive may be connected to a personal computer 120 by way of a USB port (not shown) such that the digital experience can be accessed. The digital experience may be pre-stored on the digital delivery device or may be downloaded to the digital delivery device at the computing device 110.

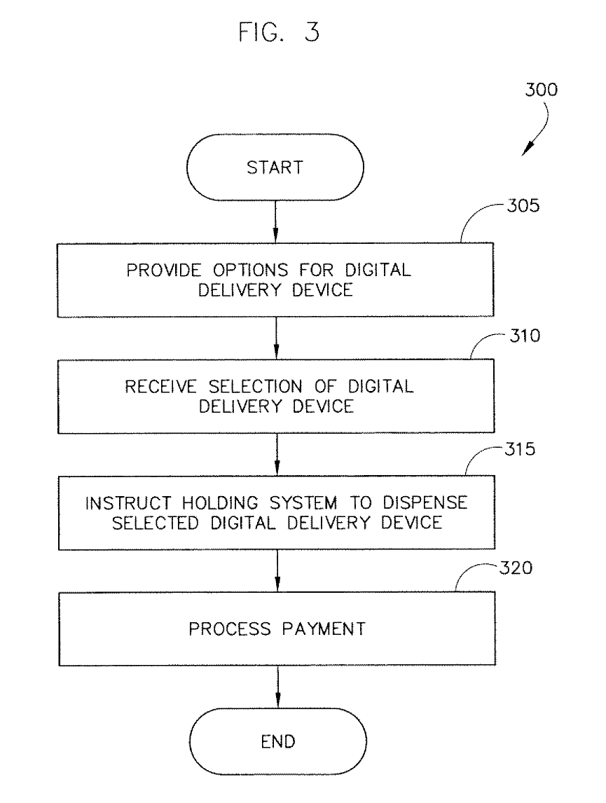

In an exemplary embodiment as illustrated in FIG. 3, the digital delivery device may be selected at the computing device 110 and delivered to the digital card purchaser at the computing device 110 or at another location in the retail store 105. For example, referring to FIGS. 1 and 3, the process begins at the START step and continues to step 305, where a greeting card purchaser can use the selection device 210 and display 215 of the computing device 110 to scroll through a list of options (e.g., a list of digital delivery devices and digital experiences stored on each digital delivery device) and, in step 310, choose a digital delivery device that she wishes to combine with a greeting card she has selected at the retail store 105. Once the purchaser identifies the digital delivery device for combining with the greeting card, according to an exemplary embodiment, the computing device may instruct the holding system 220 to dispense the selected digital delivery device in step 315 so that the purchaser may purchase the greeting card and selected digital delivery device. Alternatively, as shown in step 325, the computing device 110 may allow a purchaser to enter payment information for the greeting card and/or digital delivery device using the selection device 210 and/or display 205. Further, according to another exemplary embodiment, the purchaser may pick up the digital delivery device at another location, either in the retail location or outside the retail location.

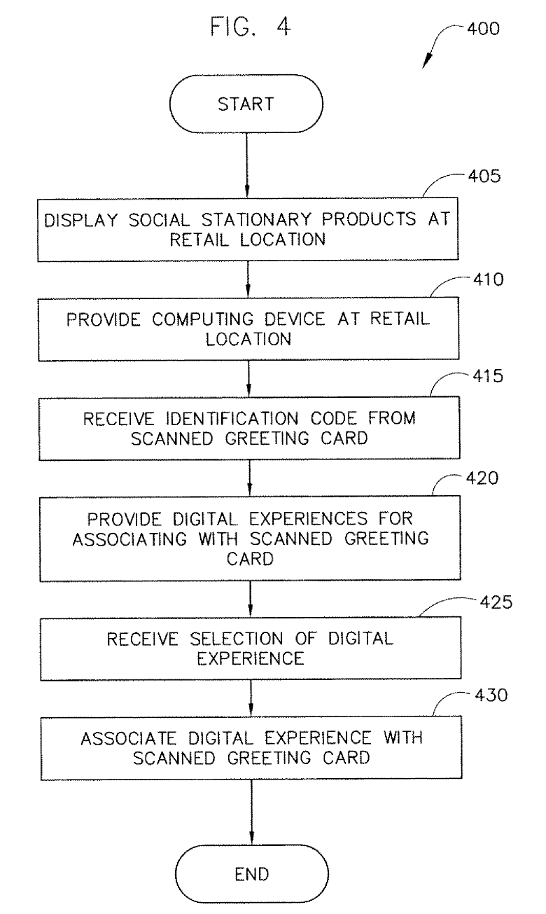

FIG. 4 illustrates an exemplary method for utilizing a computing device 110 to preview or alter the content of a digital experience that is associated with a greeting card. Referring now to FIGS. 1, 2, and 4, the process begins at the START step and continues to step 405, where a display containing greeting cards is provided at a retail location. In step 410, a computing device 110 may further be provided at the retail location. The computing device 110 may be positioned in close proximity to the greeting card display. Utilizing the scanner 215 connected to the computing device 110, a purchaser may scan an identification code (e.g., UPC code or other barcode) on the greeting card. The scanner 215 forwards the code to the computing device 110 in step 415, and the computing device 110 provides one or more digital experiences to associate with the greeting card on the display 205 in step 420. The digital experiences displayed to the purchaser may comprise those best suited for the scanned greeting card (as set by the greeting card company) or may comprise all available digital experiences.

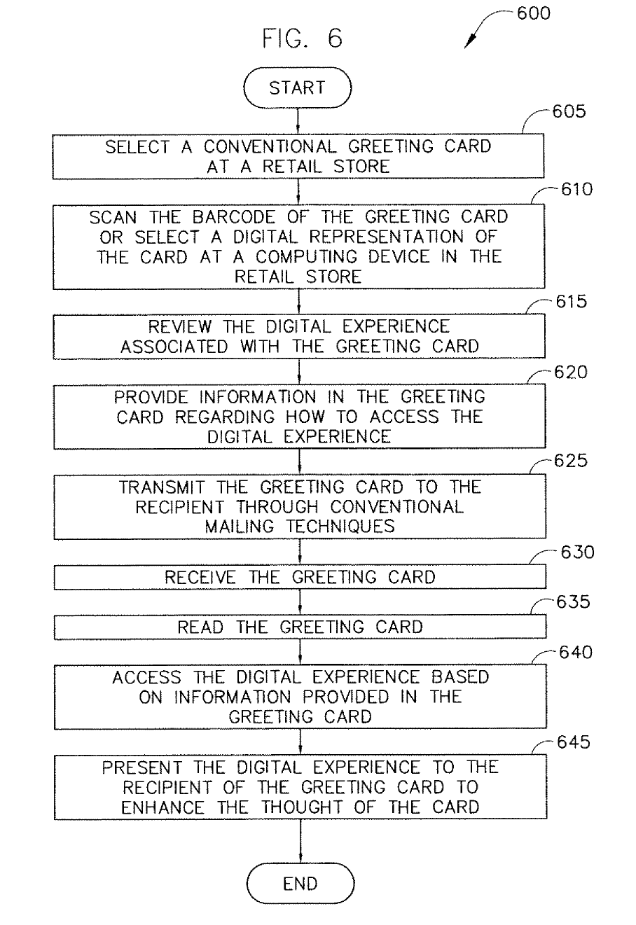

Using the selection device 210, the user may instruct the computing device 110 to associate one or more digital experiences with the greeting card in step 425, and the system may associate, in step 430, the scanned greeting card with the digital experience such that a recipient of the greeting card can access the selected digital experience (e.g., the URL in the greeting card may be associated with the selected digital experience). In an alternative embodiment, the selected digital experience can be stored onto a digital delivery device, such as a flash drive with USB connection, and provided to the card purchase either at the computing device 110 (see FIG. 6) or at another location inside of or outside of the retail store 105 for association with the greeting card.

Further, in one exemplary embodiment, the purchaser may customize the greeting card in step 425 by entering information into the computing device 110 or, alternatively, using a remote computer to enter information into a website for selecting a digital experience. For example, if a user chooses to customize the digital experience at a retail location, she may use a selection device 210 connected to the computing device 110 to insert the recipient's name into the digital experience prior to or after associating the digital experience with the greeting card. Similarly, if the purchaser chooses to customize the digital experience at a remote location, she may use a website to customize the digital experience and associate the digital experience to the greeting card. In either case, however, the recipient can receive a customized digital experience that enhances the expression of the thought in the greeting card. Examples of how the system can customize a digital experience include, but are not limited to, adding text, adding images, adding audio, and adding video. For example, in one exemplary embodiment, a purchaser may add the recipient's name to a song that comprises the digital experience. In another example, a purchaser may add an image or video of the recipient to customize the digital experience.

In addition, in an exemplary embodiment, the computing device 110 can send e-mail messages to the recipient of the greeting card to inform her of the digital experience or digital delivery device. For instance, a purchaser may choose to forward the digital experience directly to an e-mail address for presentation at the recipient computer 125. To provide the recipient's e-mail address or to provide information about the recipient, the purchaser may use the selection device 210 (e.g., the purchaser may scroll through a virtual keypad on the display or a keypad or keyboard may be attached to the computing device 110 for direct input of the information without use of the selection device).

With regards to one exemplary embodiment involving lottery tickets, the purchaser could scan a greeting card at the computing device 110 and be presented with digital or conventional lottery tickets or a link to conventional lottery tickets that are specifically designed to be combined with the particular greeting card, or the consumer may be presented with several different types of lottery tickets that share one or more characteristics of the greeting card from which the consumer may choose one or more. The lottery tickets may then be received at the computing device 110 (e.g., by utilizing the holding system 220); at the counter of the retail store; in an electronic format on a digital delivery device; or sent directly via link or standard mail to the purchaser or the card recipient.

The computing device 110 can also take the form of a hand-held electronic device, which may include, but is not limited to, cell phones, hand-held scanners, personal data assistants and other similar devices known to those of ordinary skill in the art that are capable of accessing the Internet or local access network for obtaining information regarding digital experiences associated with greeting cards. In yet another alternative embodiment, the exemplary computing device 110 can simply comprise a computer (not shown) placed within the retail store 105 in a place that is accessible to the greeting card purchaser. The computer can provide similar content and capabilities as that of the computing device 110.

In another exemplary embodiment, a greeting card display can include a catalog, book, or other pamphlet-like display. The catalog can include a listing or presentation of examples of digital experiences that are associated with the greeting cards in the display, such that a card purchaser can flip through the pages of the catalog to view “stills” or other exemplary descriptions of the digital experiences. For example, the catalog can include a range of supplemental mediums or digital experiences available to a card purchaser.

Moreover, in addition or in lieu of the catalog, the computing device 110 may be utilized to display a representation of the digital experience associated with one or more of the greeting cards. According to one embodiment, a video on a loop may be run on the display 205 connected to the computing device 110 showing previews of the digital experiences. In this way, a user may simply observe the screen, which may be located in close proximity to a greeting card display, to learn more about one or more digital experiences associated with the greeting cards.

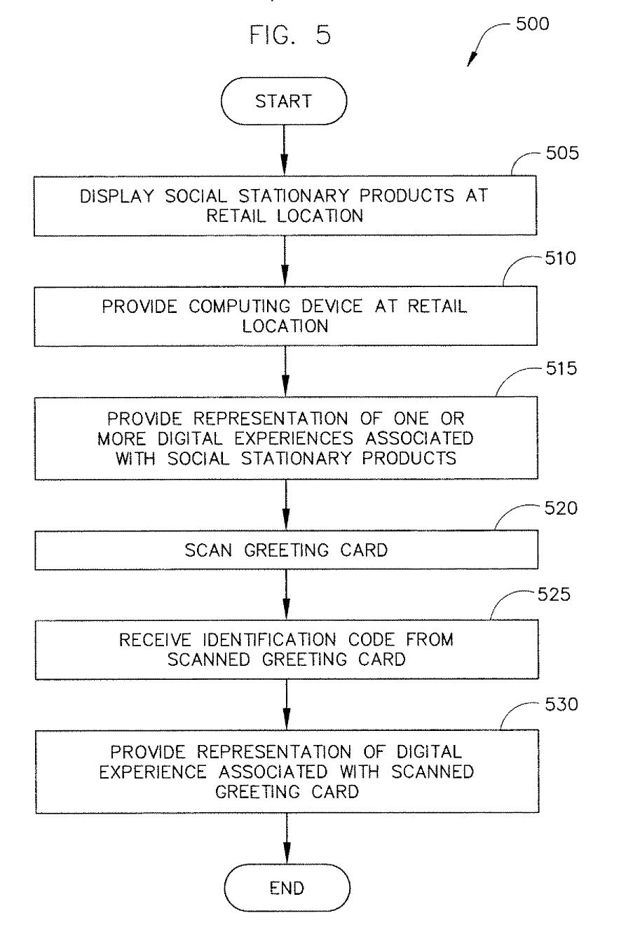

Further, in an exemplary embodiment, the scanner can be used by a purchaser to prompt the computer to display a representation or preview of the digital experience when an identification code (e.g., UPC code or another barcode) on the greeting card is scanned. This is illustrated in FIG. 5. Referring now to FIGS. 1 and 5, the process begins at the START step and continues to step 505, where a display containing greeting cards is provided at a retail location. According to an exemplary embodiment, a computing device 110 may further be provided at the retail location in step 510. The computing device 110 may be placed in close proximity to the greeting cards display. In step 515, the computing device shows a representation of one or more of the digital experiences associated with the greeting cards. For example, a video may be shown on the display 205 of the computing device 110 showing previews of each digital experience.

According to a further exemplary embodiment, if equipped with a scanner, the computing device may also be used to display a representation of the digital experience associated with a particular greeting card. Thus, in step 520, a potential purchaser scans an identification code located on the greeting card using the scanner 215. The identification code may be any machine-readable code imprinted on the greeting card, e.g., a barcode. In step 525, the scanner sends the identification code to the computing device 110. The computing device either searches its memory or accesses the web server 115 to display a representation of the greeting card in step 530. The representation may comprise a preview of the digital experience associated with the greeting card and may be provided on the display 205 communicably connected to the computing device.

Referring back to FIG. 1, in addition to being connected to the computing device 110, the web server 115 is also capable of being communicably connected to the card purchaser computer 120 and the recipient computer 125. According to an exemplary embodiment, the web server 115 can store or provide access to web pages for selecting or reviewing digital experiences to associate with a greeting card, or present digital delivery devices that can be associated with a greeting card. The card purchaser can access the web server 115 over the Internet via the card purchaser computer 120 (or remote computer) to review and select digital experiences and/or digital delivery devices. In one exemplary embodiment, the card purchaser computer 120 is a personal computer (“PC”); however, other devices known in the art for accessing the Internet may also be used. Further, in an exemplary embodiment, the recipient accesses the web server 115 over the Internet via the recipient computer 125 to access and view the digital experience that is associated with the card sent to the recipient. The recipient computer 125 may be a PC or other device known by one of ordinary skill in the art for accessing the Internet. In another exemplary embodiment, the card purchaser computer 120 and the recipient computer 125 are the same device.

FIGS. 6 through 12 are logical flowchart diagrams illustrating exemplary methods of providing digital experiences for a greeting card through the digital experience system 100. FIG. 6 is a logical flowchart diagram presented to illustrate the exemplary process 600 for selecting a greeting card that provides access to a digital experience within the operating environment of the exemplary digital experience system 100. Now referring to FIGS. 1 and 6, the exemplary method 600 begins at the START step and proceeds to step 605, in which a purchaser selects a greeting card at the retail store 105. In one exemplary embodiment, the greeting card is grouped with similar products on a greeting card display.

The card purchaser may scan the barcode on the greeting card with the scanner 215 or select a digital representation of the card at the computing device 110 in step 210 using the scanner 215. In one exemplary embodiment, the computing device 110 may include one or more “attract mode” screens for attracting potential card purchasers to the greeting card display. In one exemplary embodiment, the attract mode of the computing device shows representations of the digital experience. For example, the computing device may show a video previewing the digital experiences associated with one or more of the greeting cards.

Several additional attract modes may be presented at the computing device 110. In one exemplary embodiment, a user may select the greeting card displayed on the computing device in the attract mode. For example, in one attract mode, the first and third pages of a greeting card may be shown on the display 205, allowing a user to select the card on the computing device 110 to preview the digital experience and/or digital delivery device associated with the selected card. Similarly, in another attract mode, the front exterior page of one or more cards is presented. When a card purchaser selects one of the cards on the computing device display 205, the first and third pages of the greeting card are presented. Upon selection of one of the pages of the card on the computing device display 205, a preview of the digital experience or digital delivery device associated with that particular card is presented at the computing device display. In yet another exemplary embodiment, the front exterior page of one or more cards is presented on the computing device display 205 in the attract mode. When a card purchaser selects one of the cards on the computing device display, the first and third page of the selected card in addition to a screenshot of the digital experience associated with that card is presented on the computing device display. Upon selection of one of the pages of the card or the screenshot on the computing device display 205, a preview of the digital experience or digital delivery device associated with that particular card is presented at the computing device display.

In addition, in one exemplary embodiment, an attract mode may include a presentation for how to use the computing device 110, which may include a separate presentation option. For instance, in an exemplary embodiment, the computing device 110 (or website if the card purchaser is accessing the system from a place other than the computing device 110 or a connected internal system) is capable of presenting one or more instruction screens for assisting the card purchaser in learning how to preview, access, revise, or select a digital experience and/or digital delivery device.

Turning back to FIG. 6, an exemplary method for enhancing an expression of a thought in a greeting card is illustrated. In step 615, the card purchaser reviews the digital experience associated with a greeting card. In step 620, information is provided in the greeting card regarding how to access the digital experience. In one exemplary embodiment, a URL may be pre-printed in the greeting card. For example, below a message in a greeting card a URL may be displayed with a note requesting that the recipient visit the website for a digital experience. In another exemplary embodiment, the URL, as well as a preview of the digital delivery device associated with the greeting card, is presented on the greeting card. In another exemplary embodiment, the URL or web address for accessing the digital experience may be inserted into the greeting card by the card purchaser.

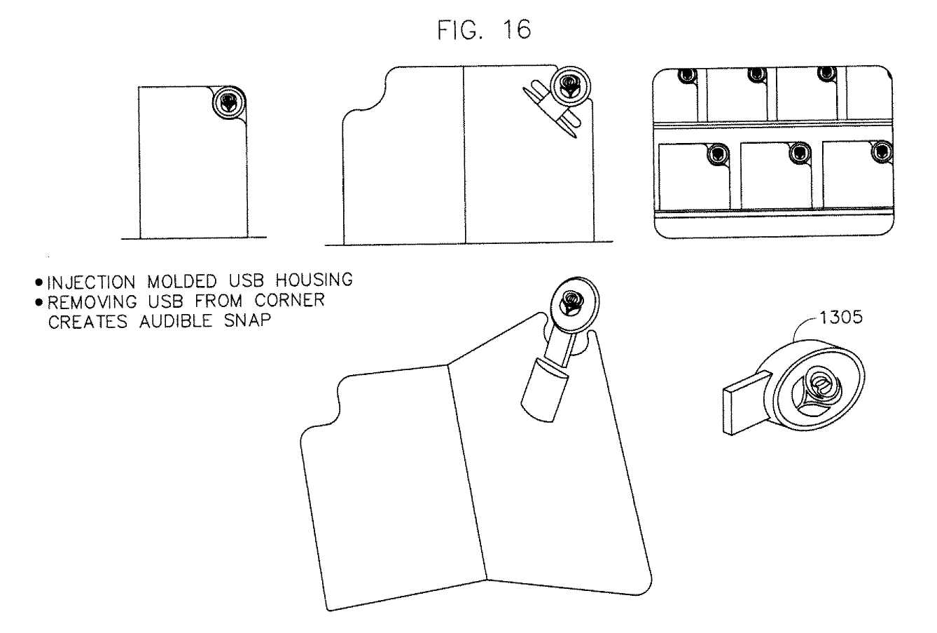

In yet another alternative embodiment, the card purchaser selects a digital experience at the computing device 110, and the computing device 110 prints a label that includes the URL for accessing the digital experience that can be affixed to the greeting card. In an alternative or additional embodiment, a digital delivery device, lottery ticket, or gift certificate may be affixed to or included with the greeting card (see FIGS. 13-22.) Further, in an exemplary embodiment that includes a digital delivery device, the device may be attached to the computing device 110 so that a digital experience (in the form of digital content) may be downloaded to the digital delivery device from the computing device 110.

With regard to the implementation of the URL with lottery tickets, the URL may provide access to a lottery website (e.g., a website maintained by a lottery organization) where digital lottery tickets or another type of digital experience may be accessed. The URL may provide the recipient instructions on how to receive or access the gift of lottery tickets. Further, the URL may request information from the recipient on where to send the gifted lottery tickets via conventional mailing techniques.

Referring back to FIG. 6, after the greeting card and URL are merged, in step 625, the card purchaser transmits the greeting card to the recipient using conventional techniques, such as by using the U.S. Postal Service. In step 630, the recipient receives the greeting card and reads the card in step 635. The recipient uses the recipient computer 125 to access the digital experience associated with the greeting card based on the URL provided in the card in step 640. In the alternative embodiment that includes a digital delivery device, upon receipt of the greeting card, the recipient may electronically couple the digital delivery device to the recipient computer 125 to access the digital experience.

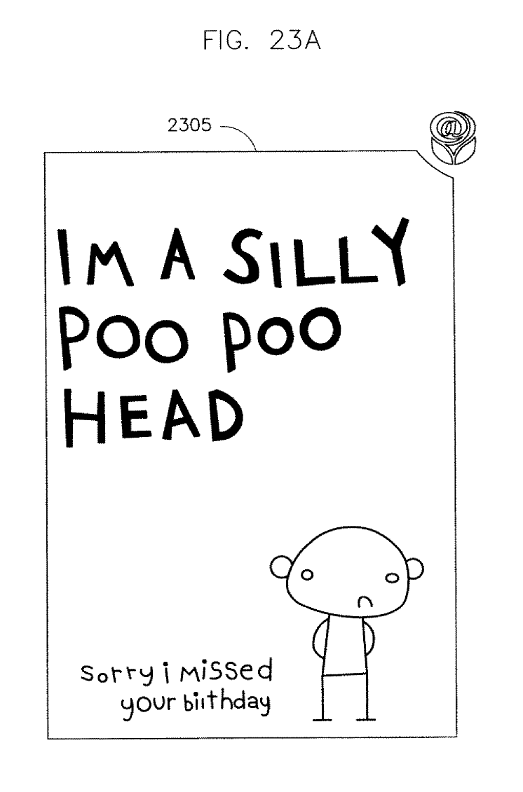

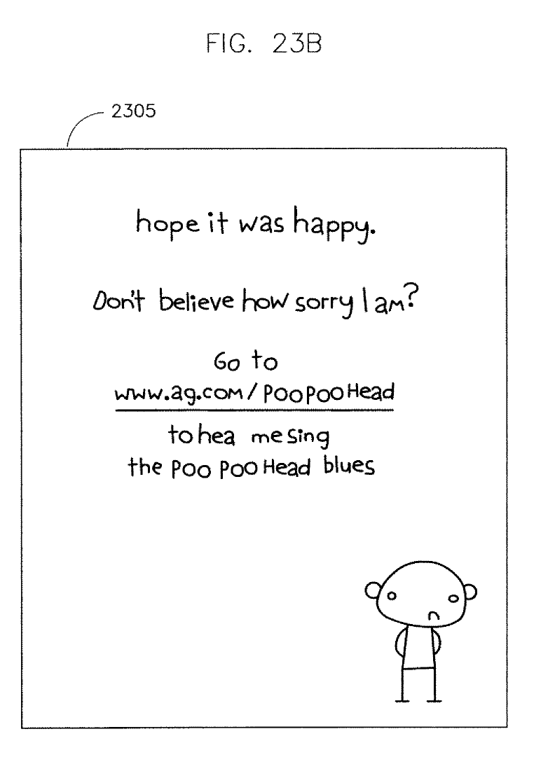

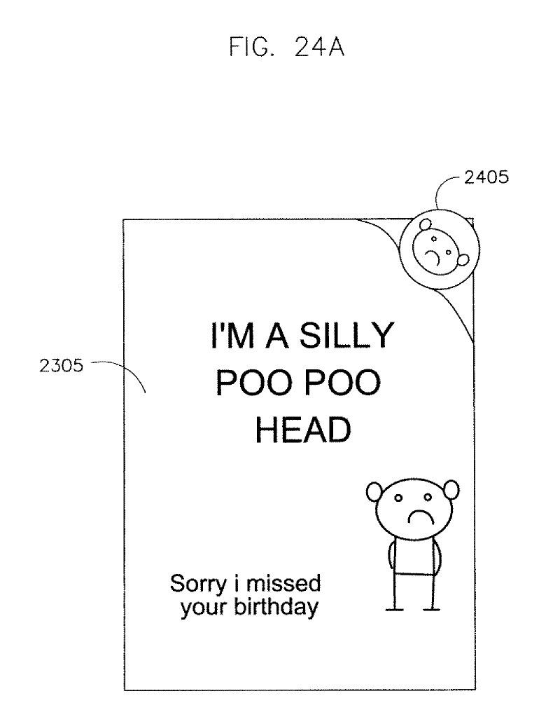

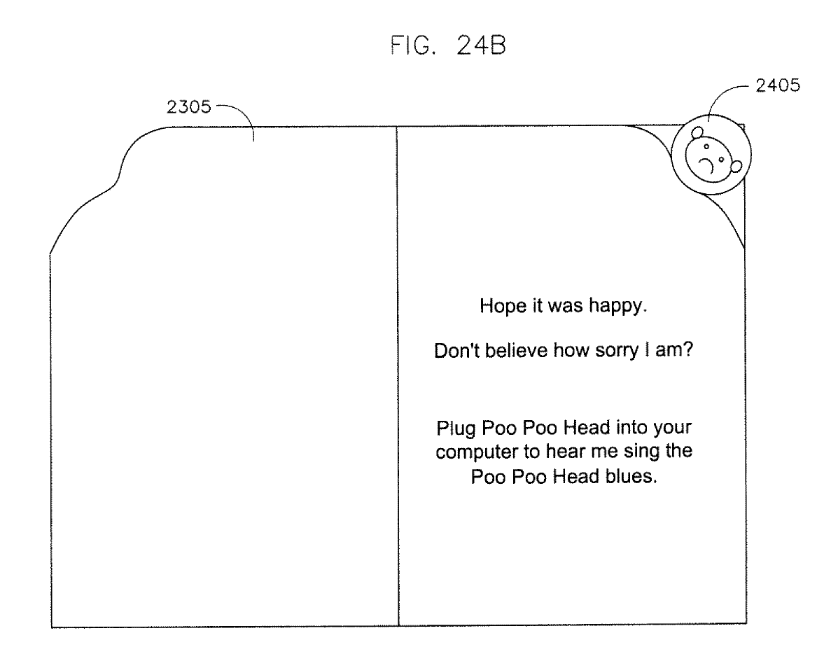

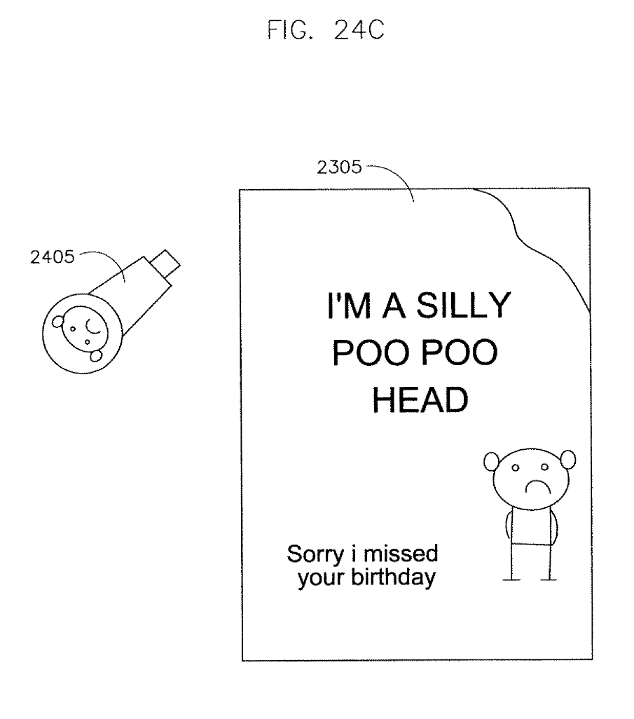

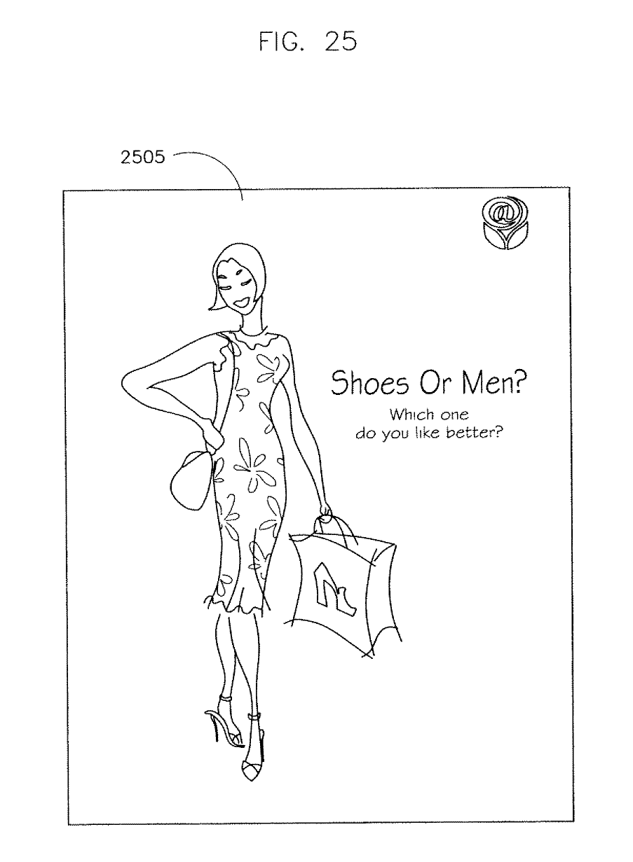

In step 645, the web server 115 presents the digital experience to the recipient of the greeting card at the recipient computer 125 to enhance the thought of the greeting card. For example, if the card purchaser selected a card with the words “I'm a Silly Poo Poo Head,” as illustrated in FIGS. 23a-23b and 24a-c, the recipient of the card 2305 could go to a website using a URL in the card (as illustrated in FIGS. 23a-b) or insert the digital delivery device 3710 (as illustrated in FIGS. 24a-c) to access digital content comprising a “silly Poo Poo Head” song. Similarly, as illustrated in FIGS. 25-26, a card may contain a question asking the recipient whether she likes something more than something else, and the card may contain a URL directing the recipient to a website that comprises a digital experience in the form of a quiz or game related to the question. In this way, the digital experience enhances the thought of the greeting card. In an alternative embodiment, a third party website or web server can present the digital experience to the card recipient instead of the web server 115. Once the recipient has accessed the digital experience, the process continues from step 645 to the END step.

Other digital experiences that can be associated with a greeting card to enhance the thought contained in the greeting card include, but are not limited to, a website comprising a computerized miniature golf game that can be played by the recipient, a website allowing the recipient to create her own poetry, a website allowing the recipient to pose questions to a computerized version of a school cafeteria worker, and a website comprising a group of puppies barking a rendition of the song “Happy Birthday.” In each of the examples above, the greeting card and digital experience have common themes or characteristics that allow the digital experience to enhance the thought of the greeting card.

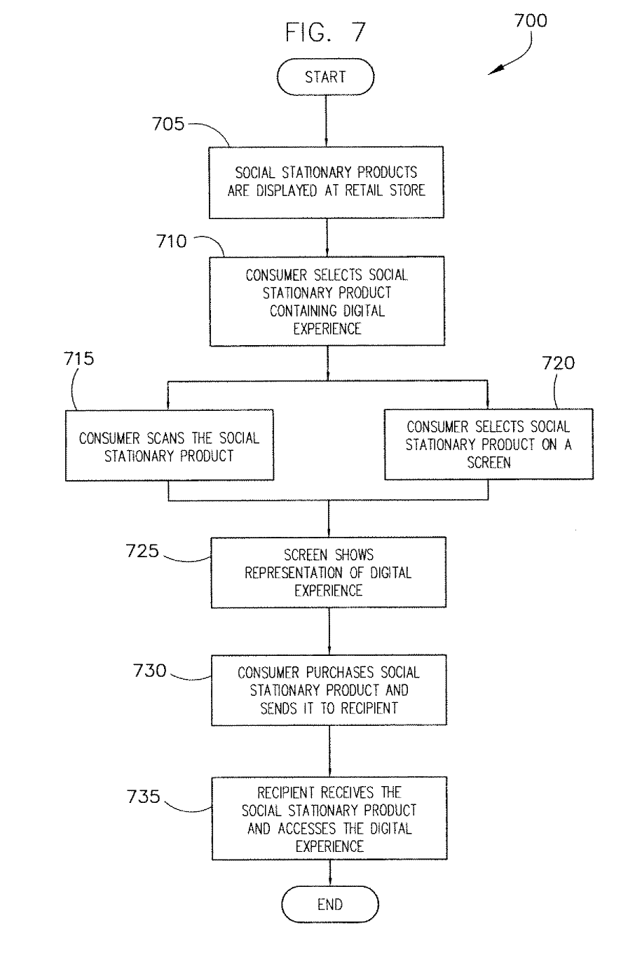

FIG. 7 is a logical flowchart representing another exemplary embodiment for enhancing an expression of a thought in a greeting card with a digital experience. Now referring to FIGS. 1 and 7, the process begins at the START step and continues to step 705, where a display containing one or more greeting cards is placed at a retail location 105, thereby allowing consumers to access and purchase the greeting cards. According to this exemplary embodiment, at least a portion of the greeting cards are or can be associated with a digital experience. Accordingly, in step 710, a consumer selects one of the greeting cards that has a digital experience associated with it. In an exemplary embodiment, the greeting card comprises a URL listing a website where the digital experience can be accessed; however, in an alternative or additional embodiment, a digital delivery device containing the digital experience may be provided with the greeting card.

Regardless of how the digital experience is associated with the greeting card, according to an exemplary embodiment, the consumer scans an identification code on the greeting card in step 715. This step may be performed at a computing device 110 with a scanner 215 or using any other type of scanner connected to a computer. Alternatively, in step 720, the user may locate the greeting card on a computing device or screen connected to a computer and may select the greeting card using an input device, such as a mouse, or by simply pressing the screen (i.e., using touch-screen technology).

Once the user has scanned or selected the greeting card, the computing device or screen shows a representation of the digital experience illustrated with the greeting card in step 725. This representation may be a sample of the digital experience or, e.g., in the case of a song, may be the entire digital experience.

Based on the representation, the consumer may decide to purchase the greeting card in step 735 (or, alternatively, the consumer may wish to repeat the process by selecting a different greeting card). If the consumer selects to purchase the greeting card, they may write a message in the product and send it to the recipient in step 735. In an exemplary embodiment, the consumer may send the greeting card through conventional techniques, such as by conventional mailing techniques; however, the consumer may also simply provide the greeting card to the recipient in person.

Once the recipient receives the greeting card, she will be able to access an expression of a thought contained in the greeting card (e.g., written text stating “Happy Birthday”), in step 735, and, in addition, she will be able to access the digital experience associated with the greeting card. For example, if a digital delivery device accompanies the greeting card, the recipient may access the content on the digital delivery device using her computer. Alternatively or additionally, if a URL is contained within the greeting card, the recipient may use the recipient computer 125 in order to access the website containing the digital experience. In either case, the digital experience is designed to enhance the expression of the thought contained in the greeting card, and the digital experience and/or digital delivery device may contain themes and/or characteristics in common with the greeting card (e.g., the digital experience that is associated with a “Happy Birthday” card comprises the “Happy Birthday” song). The process then continues from step 735 to the END step.

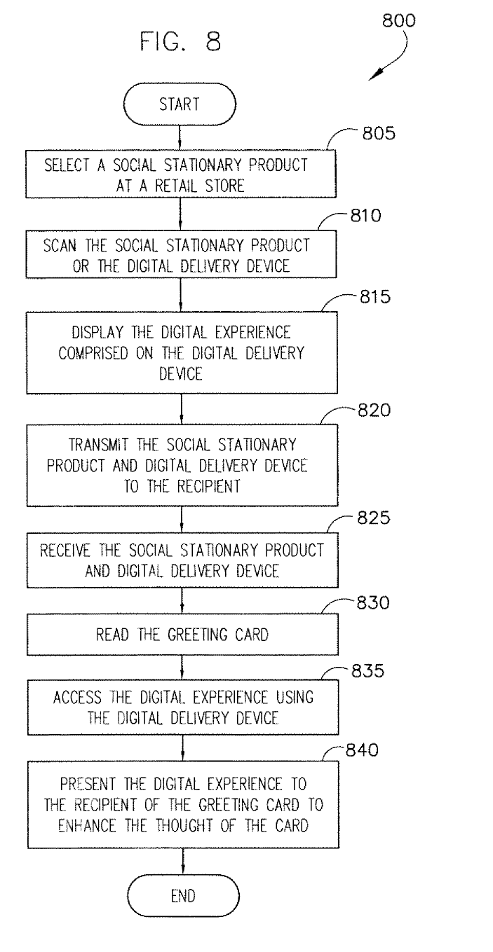

As discussed, the digital experiences does not have to reside on a website, but can also be provided to a recipient through the use of a digital delivery device associated with the greeting card. FIG. 8 illustrates an exemplary method for enhancing the expression of a thought found in a greeting card utilizing a digital delivery device. Now referring to FIGS. 1 and 8, the process 800 begins at the START step and continues to step 805, where a purchaser selects a greeting card. In one embodiment, a digital delivery device is pre-packaged with the greeting card (see, e.g., FIGS. 13-22). However, if the digital delivery device is not pre-packaged with the greeting card, the purchaser may select a digital delivery device from a digital delivery device display at the retail location in step 805. In step 810, the purchaser may scan an identification code on either the greeting card or digital delivery device to see a representation of the digital experience in step 815. For example, if the digital delivery device is pre-packaged with the greeting card, then the purchaser may simply scan the identification code (e.g., barcode) of the greeting card to view a presentation of the digital experience contained on the pre-packaged digital delivery device. In contrast, if the digital delivery device is not packaged with the greeting card, then the purchaser may scan an identification code located on the digital delivery device.

The purchaser can scan the identification code in step 810 using the scanner 215 coupled to the computing device 110 (or other combined device, e.g., using a kiosk). Accordingly, once the greeting card or digital delivery device is scanned, according to an exemplary embodiment, the computing device 110 will display a representation (e.g., sample) of the digital experience contained on the digital delivery. Then, if the purchaser is satisfied with the greeting card and associated digital experience, she may purchase the items at the retail location and proceed to step 820, where the greeting card and digital delivery device are transmitted to a recipient. The items may be transmitted in any conventional manner, such as by simply providing the greeting card and digital delivery device to the recipient or mailing the items to the recipient.

Once the recipient has received the items in step 825, she may read the greeting card in step 830 to receive the expression of a thought. Then, in step 835, the recipient may choose to utilize the digital delivery device to access the digital experience. The manner in which the digital experience is accessed depends on the digital delivery device. For example, if the digital delivery device is a CD, then the digital experience is accessed by the recipient by playing the CD using a CD player. However, if the digital delivery device is a USB flash drive or memory card, the recipient may insert the flash drive or memory card into her computer to access the digital experience.

According to an exemplary embodiment, both the digital delivery device and digital experience share common themes and/or characteristics with the greeting card. For example, the artwork of the greeting card may match the artwork of the digital delivery device as well as the artwork used in the digital experience.

In step 840, the digital experience is presented to the recipient to enhance the thought of the greeting card. As described, the thought may be enhanced in a variety of ways, such as through games, videos, music, etc. The process then continues from step 840 to END.

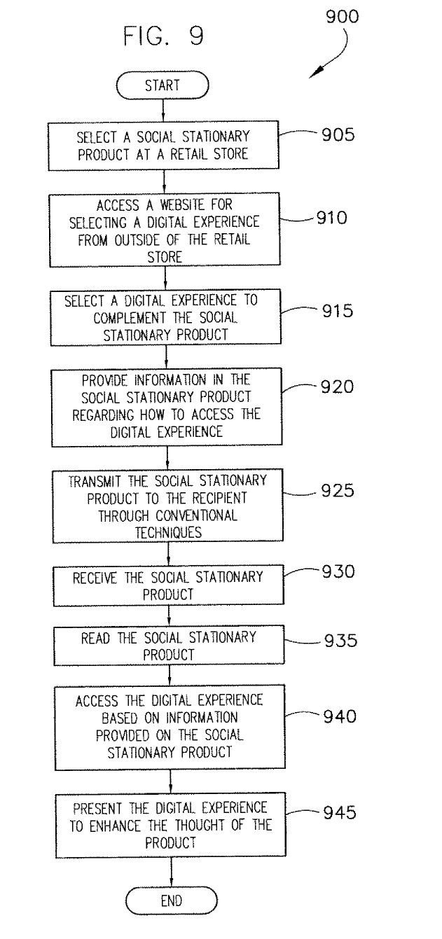

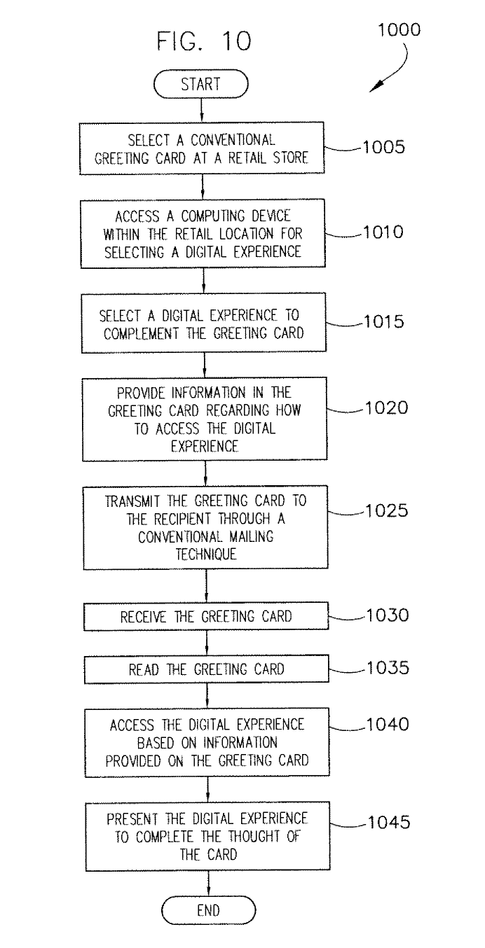

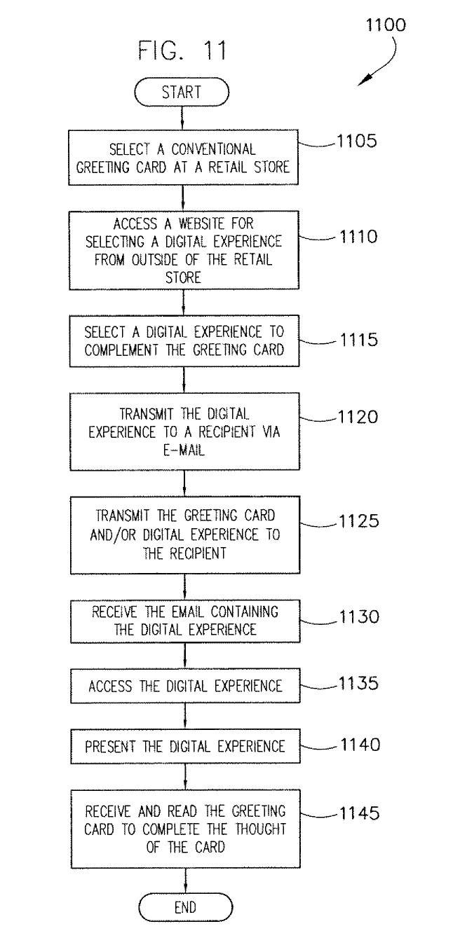

FIG. 9 is another logical flowchart diagram presented to illustrate the exemplary process 900 for remotely associating a digital experience with a greeting card within the operating environment of the exemplary digital experience system 100. Now referring to FIGS. 1 and 9, the exemplary method 900 begins at the START step and proceeds to step 905, in which a purchaser selects a conventional paper greeting card at the retail store 105.

The product purchaser uses the product purchaser computer 120 to access a website through the web server 115 to select a digital experience in step 910. In an exemplary embodiment, the product purchaser accesses the web server 115 from a location outside of the retail store 105, such as from their home, office, or other Internet accessible location. That is, the purchaser accesses the web server 115 outside the retail location 105.

In step 915, the product purchaser selects the digital experience to associate with the greeting card. In one exemplary embodiment, a product purchaser may select more than one digital experience to associate with the greeting card. During the selection process, the product purchaser can review the digital experiences prior to selecting the digital experience to associate with the product. During the review, the product purchaser is presented with content about each digital experience. To associate the digital experience with the greeting card, the purchaser may provide to the web server 115 a unique identification code for the greeting card, such as a URL address, UPC code, bar code or other ID code. Also, as discussed below, the purchaser may download the selected digital experience onto a digital delivery device to be associated with the greeting card.

In step 920, information is presented in the greeting card regarding where the associated digital experience may be accessed. In one exemplary embodiment, the product purchaser provides a URL for accessing the digital delivery device associated with the greeting card. In an alternative embodiment, the URL is already pre-printed in the greeting card and is associated (or linked) with the selected digital experience when the purchaser enters a unique identification code into the website. In another alternative embodiment, the digital experience may be stored on a digital delivery device, such as a flash drive or flash memory card with USB connection; displayed adjacent to; affixed to; or included with the greeting card. In this embodiment, the digital delivery device may be attached to the purchaser computer 120 so that digital content may be downloaded into the digital delivery device from the purchaser computer 120.

Once the greeting card contains an ability to access the digital experience, the product purchaser transmits the greeting card to the recipient using conventional techniques (e.g., using the U.S. Postal Service or other transmission means) in step 925. In step 930, the recipient receives the greeting card and reads the product in step 935. In step 940, the recipient uses the recipient computer 125 to access the digital delivery device associated with the greeting card. In one exemplary embodiment, the recipient goes to the URL contained within the product to access the digital experience. In an alternative embodiment that includes a digital delivery device, upon receipt of the greeting card, the recipient may electronically couple the digital delivery device to the recipient computer 125 to access the digital experience.

If the digital experience is accessed using a URL, then, in step 945, the web server 115 presents the digital experience to the recipient of the greeting card at the recipient computer 125 to enhance the thought of the greeting card. Alternatively, if the digital experience is contained on a digital delivery device, then the computer 125 accesses the memory of the digital delivery device to present the digital experience to the recipient.

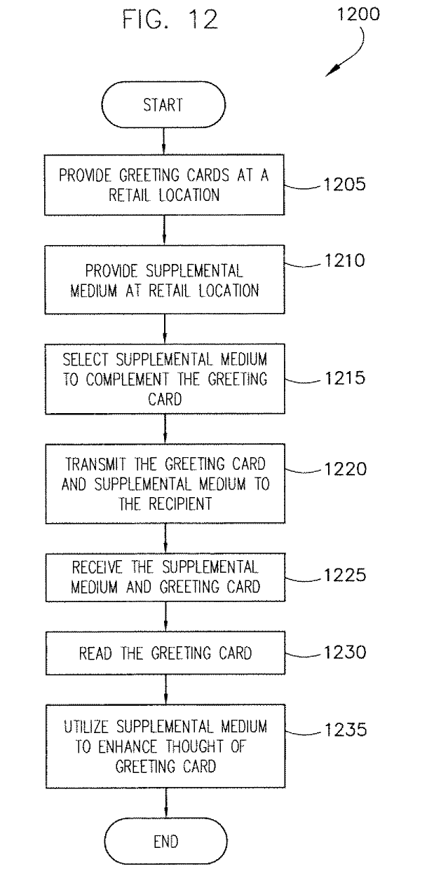

FIG. 10 is a logical flowchart diagram presented to illustrate an alternative exemplary process 1000 for selecting a greeting card and digital experience and presenting the card and digital experience to the card recipient within the operating environment of the exemplary digital experience system 100. Now referring to FIGS. 1 and 10, the exemplary method 1000 begins at the START step and proceeds to step 1005, in which a purchaser selects a conventional paper greeting card at the retail store 105.

The card purchaser accesses the computing device 110 in the retail store 105 to select a digital experience in step 1010. In one exemplary embodiment, the card purchaser can scan the barcode on the selected greeting card or select a digital representation of the card at the computing device 110 such that the computing device 110 will present an assortment of digital experiences that best complement the card. For example, lottery tickets in digital format having a theme or characteristics (e.g., artwork) consistent with the selected greeting card or messages that correspond with the selected greeting card may be presented to the card purchaser as complements to the scanned greeting card. The card purchaser can then select a digital experience from the assortment of digital experiences presented or choose to select a different digital experience available from the computing device 110. In another exemplary embodiment, the card purchaser may access the computing device 110 to select from a “full-line” of digital experiences regardless of the card she selected. In this way, the consumer can personalize the digital experience to best enhance the thought of the greeting card.

In step 1015, the card purchaser selects the digital experience to associate with the greeting card. In one exemplary embodiment, a card purchaser may select more than one digital experience to associate with the greeting card. During the selection process, the card purchaser can review one or more digital experiences prior to selecting the digital experience to associate with the card. During the review, the computing device 110 presents the card purchaser with content about a digital experience by showing a preview or other presentation of the digital experience. Once the purchaser selects a digital experience, the purchaser may be prompted to provide to the web server 115 a unique identification code for the greeting card, such as a URL address, UPC code, bar code, or other ID code. In this way, the web server 115 can know which digital experience to display when the recipient of the greeting card accesses the website. Also, as discussed below, the purchaser may download the selected digital experience onto a digital delivery device to be packaged with the greeting card.

In step 1020, information is provided in the greeting card regarding how to access the digital experience. In one exemplary embodiment, a URL may be pre-printed in the greeting card. In another exemplary embodiment, the URL or web address for accessing the digital experience may be inserted into the greeting card by the card purchaser. In an alternative embodiment, the computing device 110 prints a label that includes the URL needed to access and digital experience. The label can be affixed to the greeting card by the card purchaser. In still another alternative embodiment, a digital delivery device, lottery ticket or gift certificate may be affixed to or included with the greeting card to supplement the message or thought contained within the greeting card. In relation to this embodiment, in one example, a digital delivery device may be included with or affixed to the greeting card with pre-loaded information or, in a different exemplary embodiment, the digital delivery device may be separate from the greeting card so that a digital experience can be downloaded to the digital delivery device from the computing device 110 (see FIGS. 24a-c). Further, in another exemplary embodiment, the digital delivery device, lottery ticket, or gift certificate (i.e., the supplemental medium) contains a common theme or characteristic with the greeting card. For example, the greeting card may contain a “birthday” or “wedding” theme. Accordingly, the supplemental medium would likewise comprise a theme corresponding to the theme of the greeting card. Further, the supplemental medium may have characteristics in common with the copy of the greeting card, such as similar artwork, written text, or characters.

After the consumer has selected a greeting card and digital experience, digital delivery device, lottery ticket, and/or gift certificate, the card purchaser sends the greeting card to the recipient using conventional techniques in step 1025, such as through the U.S. Postal Service. In step 1030, the recipient receives the greeting card and reads the card in step 1035. The recipient uses the recipient computer 125 to access the digital experience associated with the greeting card based on the information provided in the card in step 1040. In step 1045, the web server 115 presents the digital experience to the recipient of the greeting card at the recipient computer 125 to enhance the thought of the greeting card. In the alternative embodiment that includes a digital delivery device, upon receipt of the greeting card, the recipient may electronically couple the digital delivery device to the recipient computer 125 to access the digital experience. Further, in the alternative embodiment that includes a lottery ticket and/or gift card, the recipient may utilize the supplemental medium such that the expression of the thought conveyed by the greeting card is enhanced. The process then continues from step 1045 to the END step.

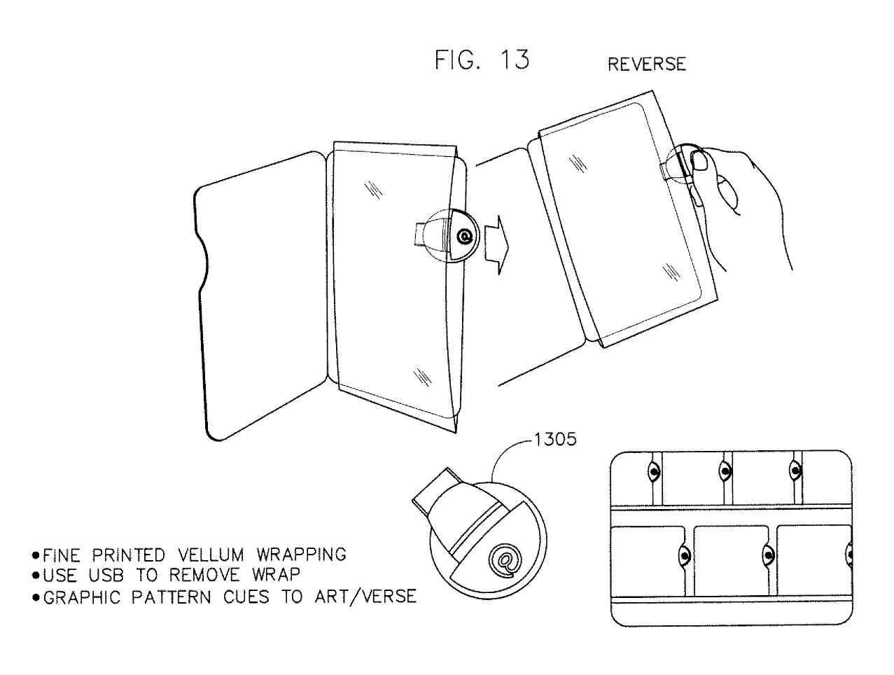

FIG. 11 is a logical flowchart diagram presented to illustrate the alternative exemplary process 1100 for selecting a greeting card and digital experience and presenting the card and digital experience to the card recipient within the operating environment of the exemplary digital delivery device system 1100. Now referring to FIGS. 1 and 11, the exemplary method 1100 begins at the START step and proceeds to step 1105, in which a purchaser selects a conventional paper greeting card at the retail store 105.

The card purchaser uses the card purchaser computer 120 to access a website through the web server 115 to select a digital experience in step 1110. In one exemplary embodiment, the card purchaser accesses the web server 115 from a location outside of the retail store 105, such as from their home, office, or other Internet accessible location. In step 1115, the card purchaser selects the digital experience to associate with the greeting card. In step 1120, the card purchaser sends the digital experience to the recipient via e-mail. In one exemplary embodiment, the e-mail includes a URL link that can be selected by the recipient to access the digital experience. In another exemplary embodiment, the digital experience is included as an attachment to the e-mail sent to the recipient. In an alternative or additional exemplary embodiment, the purchaser may download the digital experience onto a digital delivery device at the remote location and send it to the recipient.

In step 1125, the card purchaser sends the greeting card to the recipient using conventional techniques, such as by using the U.S. Postal Service. In one exemplary embodiment, the card purchaser includes information about the digital experience in the greeting card. In another exemplary embodiment, the digital delivery device is transmitted to the recipient prior to the recipient receiving the greeting card. In this way, the greeting card enhances the expression of a thought contained in the digital experience. For example, in step 1130, the recipient receives the e-mail containing the digital experience. Alternatively, the recipient may receive a digital delivery device containing the digital experience. In step 1135, the recipient accesses the digital experience from the recipient computer 125 through the web server 115 (or digital delivery device). In step 1140, the web server 115 (or digital delivery device) presents the digital experience to the recipient at the recipient computer 125. Then, in step 1145, the recipient receives and reads the greeting card to enhance the thought of the digital experience. The process then continues from step 1145 to the END step.

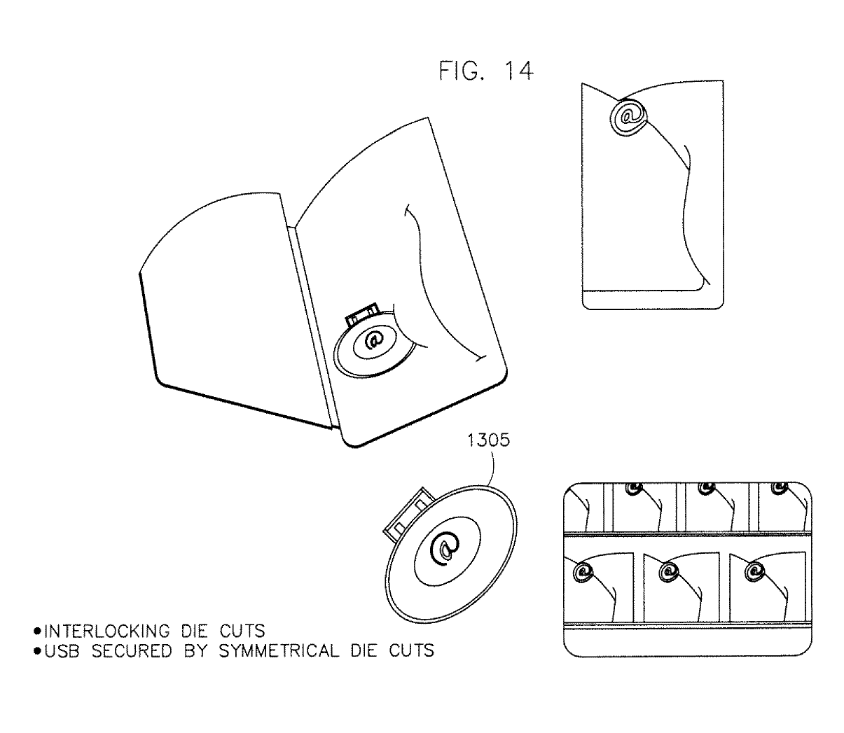

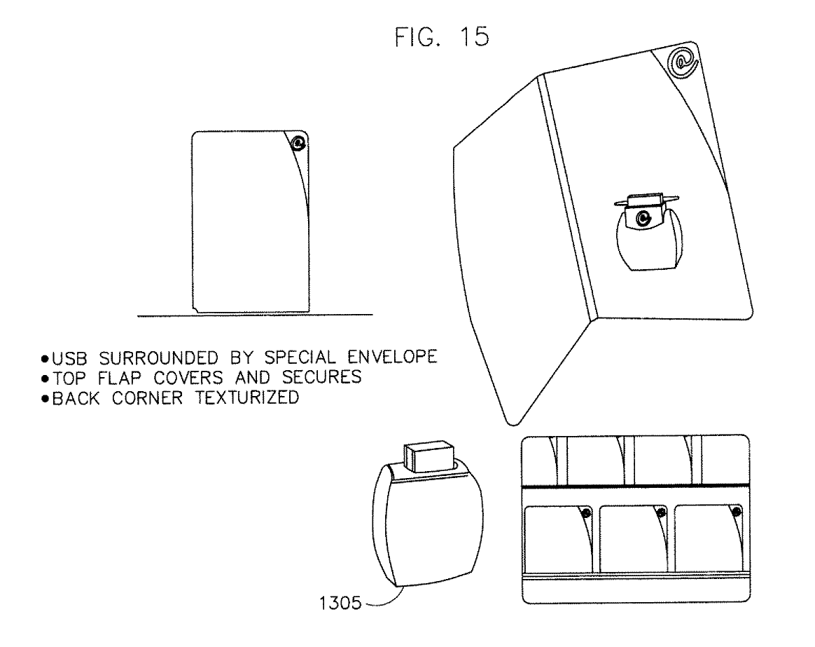

As discussed above, in another exemplary embodiment of the present invention greeting cards may be supplemented by a supplemental medium, such as digital delivery devices, lottery tickets, and/or gift cards. FIG. 12 illustrates an exemplary method for associating a greeting card with a supplemental medium, such as a gift card or lottery ticket, to enhance or the expression of a thought contained in the greeting card. The process begins at the START step and continues to step 1205, where greeting cards are displayed at a retail location in a greeting card display. Continuing to step 1210, according to an exemplary embodiment, a supplemental medium (e.g., lottery tickets) are provided at the retail location. According to an exemplary embodiment, the supplemental medium may be displayed in close proximity to the greeting cards.

In step 1215, a purchaser may select a supplemental medium and greeting card to associate with one another. Alternatively, the greeting card may be pre-packaged with a supplemental medium at the retail location; however, in either case, according to an exemplary embodiment, the supplemental medium and greeting card share common themes and/or characteristics. Once the supplemental medium is selected, it and the greeting card may be transmitted to a recipient using any conventional technique in step 1220.

The recipient receives the greeting card and supplemental medium in step 1225 and reads the greeting card in step 1230. The recipient may then utilize the supplemental medium in step 1235 to enhance the expression of the thought in the greeting card. For example, the expression of a thought contained in the greeting card may relate to food and the supplemental medium may comprise a gift certificate to a restaurant. Similarly, the expression of a thought in the greeting card may inquire whether the recipient “feels lucky,” and the supplemental medium may comprise a lottery ticket. Whatever the case, once the supplemental medium has enhanced the expression of the thought, the process moves from step 1235 to the END step.

In another example, a URL can be placed within the internal or cover copy of a greeting card (i.e., a greeting card) to allow the user to access a digital lottery ticket or gift certificate. In this way, the lottery ticket or gift certificate may comprise the digital experience associated with the greeting card (see FIG. 6). For example, the URL may be directed to a website controlled by a lottery authority/organization, the greeting card company, or a third party. Once the card recipient receives the card and sees the URL, she can access the website via the recipient computer 125. From there, the recipient may be: (1) presented with a digital lottery ticket; or (2) presented with an option to choose to purchase lottery tickets or gift cards (depending on the content provided on the website) via an electronic purchase option.

Further, as discussed above with reference to FIG. 8, in another exemplary embodiment a digital delivery device may be attached to or included with a greeting card. Information can be stored on the digital delivery device for providing or proving access to a digital experience. In this exemplary embodiment, the digital delivery device may be placed within the card in a place-holder specially designed for the digital delivery device. In addition, the digital delivery device may be placed within an internal pocket or behind one or more reveals as a surprise that is included with the greeting card. The digital delivery device could be purchased separately or included with the greeting card.

FIGS. 13-22 present several exemplary embodiments of a greeting card constructed or configured in a form that receives, holds or engages a digital delivery device, such as for example a USB flash drive (“flash drive”), memory cards, or compact flash (“CF”) storage devices, as further described. Non-limiting examples of card structures which receive, hold or engage digital delivery devices include slots, holes, die cuts or openings in one or more panels of a card; envelopes or pockets with interior volume defined by two or more panels or pieces of a card; card panels with edge profiles that accommodate or conform to a shell or housing of a digital delivery device, closures or flaps that partially or completely cover a digital delivery device; a separate digital delivery device package, envelope, pouch or pocket that is attached to or integrated with one or more panels of a card; constructs on one or more panels of the card that hold or conceal a portion of a digital delivery device and leave exposed another portion of the digital delivery device above or adjacent to a panel of the card; constructs at an edge or edges of one or more panels of a card that engage a portion of a digital delivery device and hold another portion of the digital delivery device beyond an edge of the card; constructs at or across a fold line of a card between two panels of the card that engage a digital delivery device; a portion of a card that is engaged by the housing of a digital delivery device, or engaged by the USB port of a flash drive, and any card configurations in which part or all of a digital delivery device is connected or attached to or otherwise integrated with the card.

FIG. 13 illustrates an exemplary embodiment of a greeting card manufactured to hold a digital delivery device 1305. As illustrated, a digital delivery device 1305 can be slid into a pocket (i.e., slit) in order for it to be affixed to the greeting card. FIG. 14 illustrates an exemplary embodiment of a greeting card where a digital delivery device 1305 is secured in the greeting card by the use of interlocking die cuts. In FIG. 15, a digital delivery device 1305 is secured to the greeting card by using an elastic band and a specially designed envelope. In FIG. 16, a greeting card is manufactured with an injection molded housing for securing a digital delivery device 1305. In this exemplary embodiment, the digital delivery device 1305 fits snuggly in the injection molded corner of the greeting card.

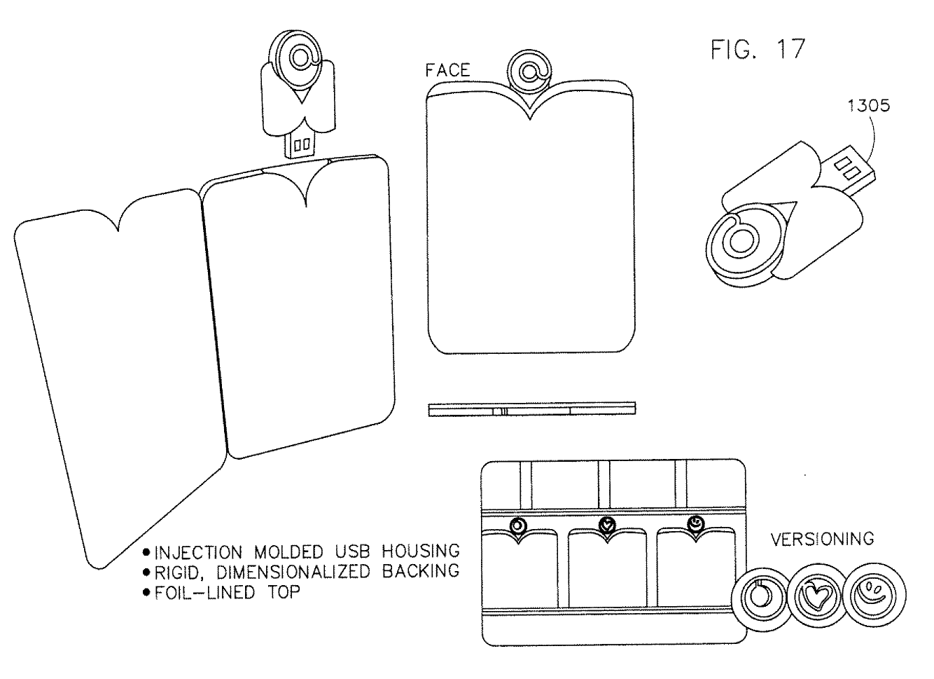

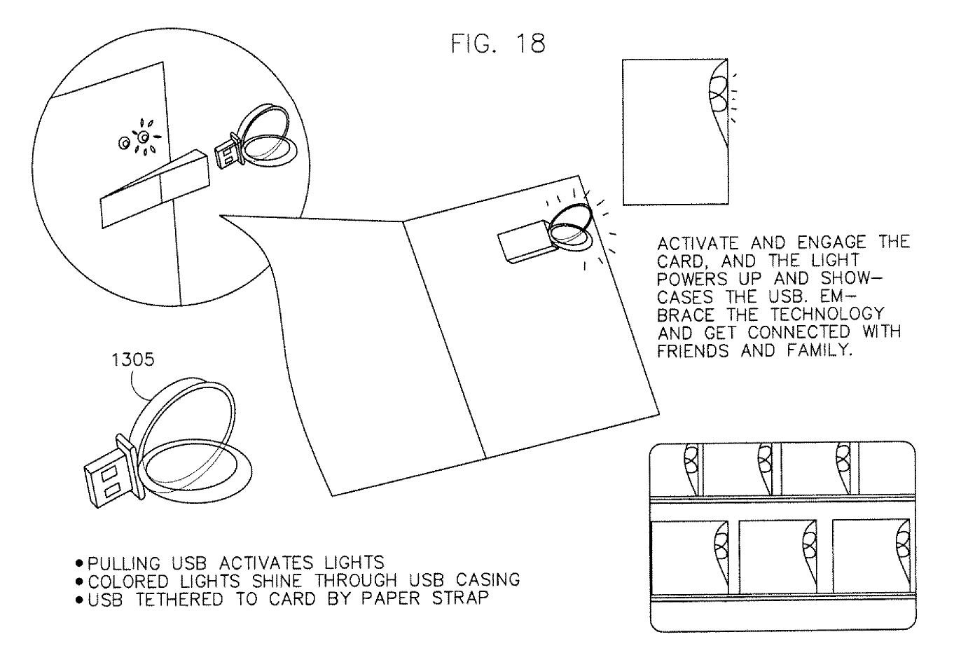

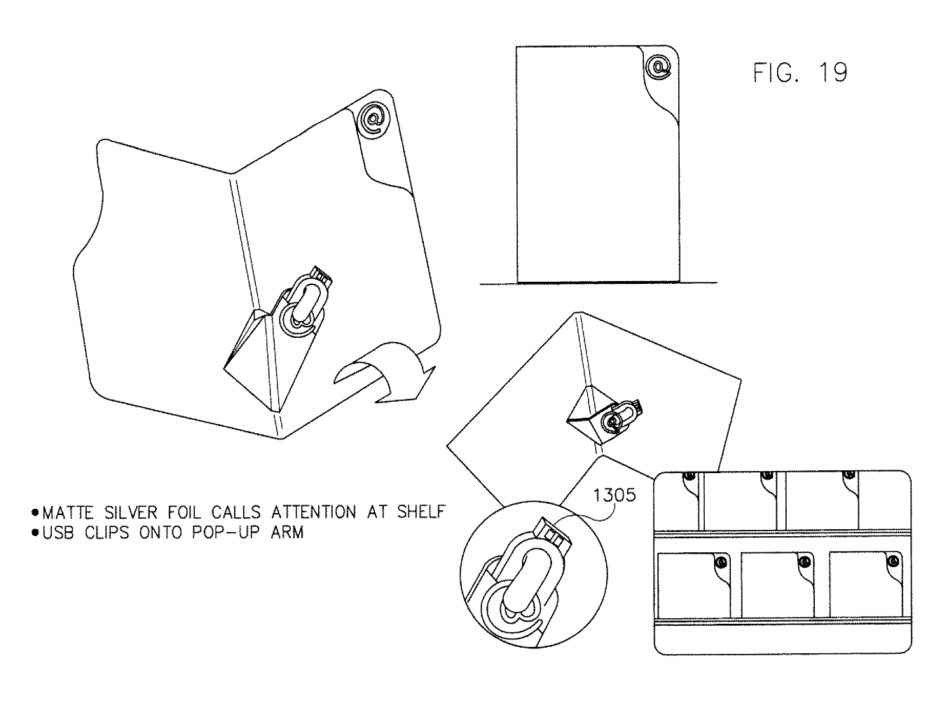

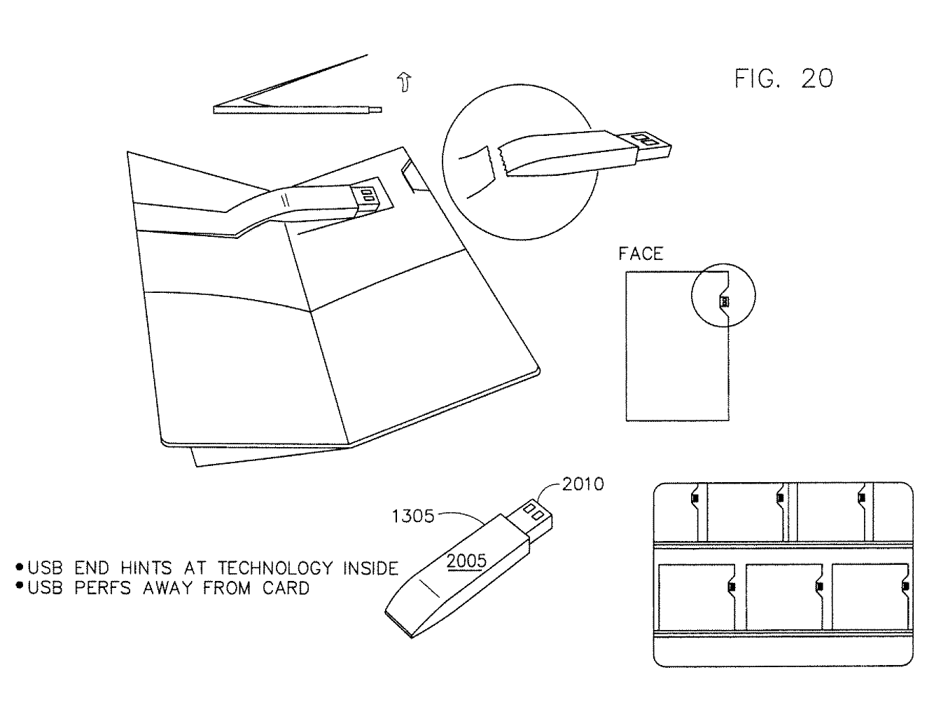

FIG. 17 illustrates another exemplary injection molded housing for a digital delivery device 1305. As illustrated, the digital delivery device 1305 is inserted at the top of a greeting card and is held in place by an injection molded housing. In FIG. 18, a digital delivery device 1305 is tethered to a greeting card by a paper strap. In an exemplary embodiment, the digital delivery device 1305 further comprises a light that is activated when it is removed from the greeting card. In FIG. 19, a pop-up, paper arm is manufactured into a greeting card for affixing a digital delivery device 1305. Accordingly, when the card is opened, the pop-up, paper arm draws attention to the digital delivery device 1305. In FIG. 20, a digital delivery device is connected to a greeting card through the use of a paper strap. In an exemplary embodiment, the digital delivery device is fixably connected to the paper strap, but can be perforated from the strap. In this way, the digital delivery device is securely attached to the greeting card and moves into a position to highlight the technology when the greeting card is in a closed position.

Any of the described greeting card configurations can be made of any suitable materials including, but not limited to, paper-based materials, synthetic or polymer sheet material, and further in combination with other materials or devices such as adhesives and fasteners for accomplishing the combination of a digital delivery device with a greeting card. For example, the digital delivery device can be incorporated with social expression products of any type or configuration, including conventional two-panel greeting cards, all other social expression products with different numbers of panels and folds, and other types of paper constructs which are not necessarily greeting cards including, but not limited to, business or calling cards, advertising mediums, mail pieces, etc.

Although the configurations of the social expression products can be adapted for interface with any type of digital delivery device (e.g., CD, DVD, etc.), a USB flash drive is shown for exemplary purposes in the various embodiments illustrated in FIGS. 13-20. USB flash drives (also referred to as “drives”, “flash drives”, “thumb drives” or “handy drives”) comprise NAND-type flash memory data digital delivery devices which have an integral universal serial bus (USB) interface. They are small, lightweight, removable and rewritable, and, in certain exemplary embodiments, have data capacities of from 32 megabytes to 64 gigabytes. Generally, flash memory is non-volatile computer memory which can be electrically erased and reprogrammed. Flash memory is typically used for general storage and transfer of data between computers and other digital devices, including computers and any type of portable or personal computing or digital device or telephone with suitable interface and data retrieval and playback or display functionality.

USB flash drives are advantageous for supplementing social expression products because of several attributes, including their relative small size, i.e., in certain exemplary embodiments, they are smaller than the typical panel size of a card. In addition, USB flash drives easily interface with computing devices via the integrated USB connector and typically have ample data storage capacity for storing data that is related to the message of the card in order to enhance the expression of the thought contained in the card. Also, the housing or shell of the flash drive, from which the USB connector extends, can be configured to compliment or fit with the card (e.g., attached to a paper strap with a paper shell on the flash drive housing). Various advantageous ways for configuring a USB flash drive are illustrated in FIGS. 13-20. Also, the exterior configuration of the housing of the USB flash drive can be made to correspond in shape, size, color or form to the shape or form of the card or to the message, theme, or purpose of the card.

A flash drive consists of a small printed circuit board in a plastic or metal housing, making it sturdy enough for the described packaging and use in connection with cards, and to be carried about in a pocket, as a key fob or on a lanyard. Typically only the USB connector protrudes from the housing and can be covered by a removable cap to prevent contamination of the circuitry (not shown). When combined with a card in accordance with the invention described herein, a portion of the card can be configured to protect the USB connector (see FIGS. 13-19). Alternatively, as illustrated in FIG. 20, the card may hold the flash drive in an orientation in which either the USB connector 2010 or the housing 2005 is exposed, thus displaying to the consumer the digital delivery device combination. Most flash drives use a standard type-A USB connection, allowing them to be connected directly to a USB port on a personal computer, such as the recipient computer 125 of FIG. 1, or any other device which has a USB port, such as for example a personal computing device, personal digital assistant (PDA), disk drive device such as a DVD player or gaming system, monitor or printer, and hybrids of such devices such as smart phones.

To access the data stored in a flash drive, it must be connected to a computer, either by plugging it into a USB host controller built into the computer, or into a USB hub. Flash drives are active only when plugged into a USB connection and draw all necessary power from the supply provided by that connection. Flash drives are widely used to transport and store personal files such as documents, pictures, audio, and video data in common formats. The data on the flash drive may comprise digital content in the form of a digital experience intended to enhance the subject matter or thought of the card. The digital content may be stock, such as a “Happy Birthday” message with audio and graphics (static or dynamic), or customized for the recipient. The content may also include links to other sources of data such as to the internet via a URL address, which may or may not have content related to the card, and which may or may not be specifically tailored to the recipient.

Other devices can be incorporated into the flash drive, carried by the flash drive chassis and contained within the housing. Examples are LEDs, LCDs, cameras, microphones and sound chips (see, e.g., FIG. 18). In this form and with audio and/or video functions, flash drives are also referred to as solid state digital audio players, an example of which is the APPLE COMPUTER IPOD SHUFFLE.

Flash drives can also be used to carry applications that run on the host computer without requiring installation onto the hard drive of the computer. Applications have been developed that run from a flash drive and utilize a PC as a host, and which network other PCs into a multi-screen, web-like work environment.

USB flash drives are highly suitable and desirable for use in the described manner for high data capacity, good protection and resistance to damage, and ease of use. The small size facilitates the described card packaging, portability, and retention of the device by the recipient even after the card is thrown away.

The invention described herein thus provides novel combinations of different types of cards or paper products with digital delivery devices, such as USB flash drives which are removable from the card, which contain digital experiences in one or more forms which corresponds to the subject matter of the greeting card. Non-limiting examples of digital data content that may form a digital experience includes, but is not limited to, digitized photo data on the digital delivery device of the recipient and/or the sender of the card, audio files, video files, text files and combinations thereof, URL links to websites, e-mail accounts or other network access, and programs which are launched from or by the flash drive to enable the recipient or user to perform computing functions. One example of a computing function (i.e., a digital experience) which can be launched or otherwise enabled by digital content on the flash drive is connection to an application for building or modifying a website. The flash drive may contain a hyperlink to a site which presents a template to the user for composing one or more website pages. Additional data content such as photos or graphics or text for the pages may be contained on the flash drive, or acquired from elsewhere.

The invention described herein further includes the use of other types and forms of digital delivery devices, including memory cards, compact flash memory cards (“compact flash” or “CF”), secure digital (SD), and secure digital high capacity (SDHC). Compact flash is a type of solid state memory device which retains data without power. It is typically in the form of a small (nominally 1″ by 1″) planar card or housing which contains one or more solid state memory chips and a memory controller. SD cards are relatively smaller in size than CF cards, and, in certain exemplary embodiments, are limited to 2 GB data capacity. One possible advantage of the use of flash drives or SD cards in practicing the invention is the availability of built-in digital rights management (“DRM”) and cryptographic features.

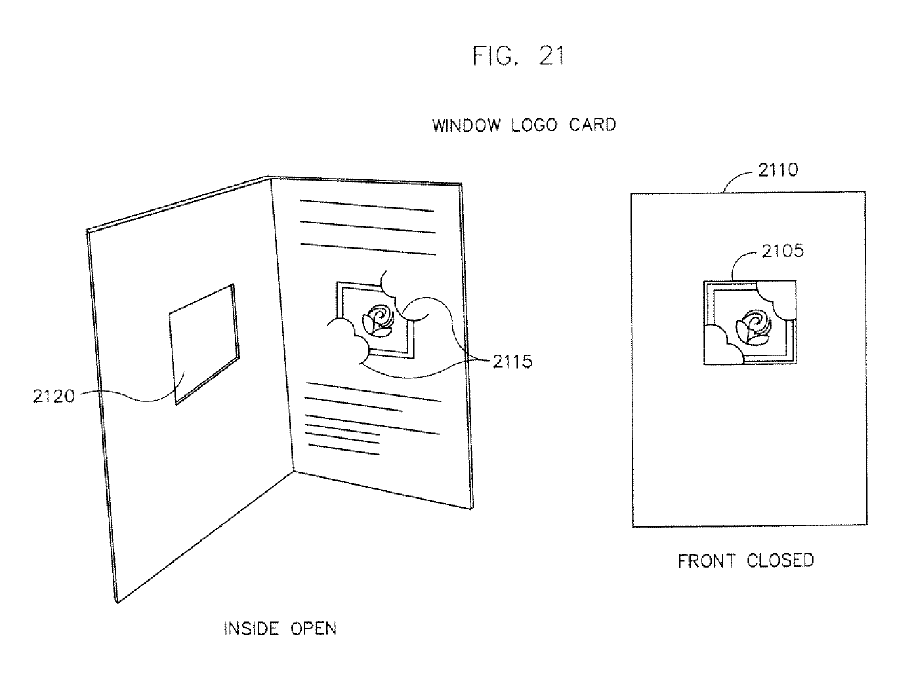

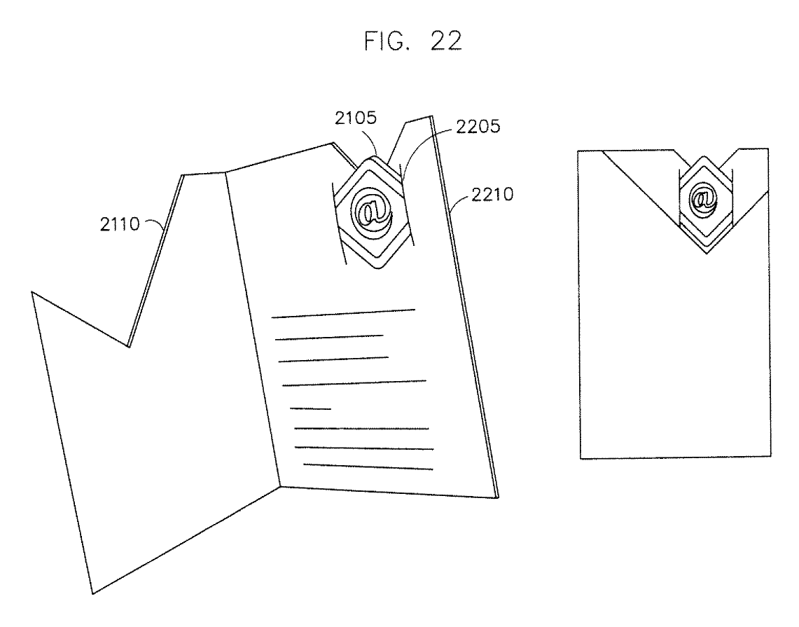

Because CF cards can be used directly in a PC card receiver slot with a plug adapter, or as an IDE hard drive with a passive adapter, and with a reader, with any number of common ports like USB, they are highly adaptable for interface with a wide variety of digital devices beyond the most common current use in digital cameras, including, but not limited to, desktop computers, laptop computers, cell phones, PDAs, television, digital television, DVD players, audio systems, video game systems, car stereos, digital audio players, MP3 players, digital audio photo frames and any other type of memory device interfaces. The very small size of memory cards and CF cards makes them ideal for the described combination with greeting cards and other social expression products. Examples of configurations of a greeting card with a CF card are illustrated in FIGS. 21 and 22. As illustrated, a CF card 2105 is incorporated into a greeting card 2110 in these embodiments. In FIG. 21, the CF card is inserted in slits 2115 in the greeting card and is viewable through a hole 2120 in the front of the card. In FIG. 22, the CF card 2105 is inserted into the upper portion of the greeting card using slits 2205 and is viewable through a cut-out 2210 on the front cover of the greeting card.

The card/delivery device combination of the invention merges multiple communication formats together, combining printed information with digital information, with each medium facilitated or complemented by the other. For example, the card may physically carry and highlight the digital delivery device, and can also provide printed reference to and instructions for use of the digital delivery device to the recipient, such as instructions for connecting the digital delivery device to a digital device such as a computer or PDA or cell phone. Conversely, the digital delivery device may contain themes or characteristics in common with the greeting card, which augments the greeting card. The digital delivery device also provides utility in addition to the card or greeting card as the delivery medium.

As described, a social expression product may alternatively or additionally be supplemented with lottery tickets and gift cards. These supplemental mediums may be either physical (i.e., conventional) or may be supplied through accessing a digital experience. The physical lottery tickets and/or gift cards, if physical, may or may not be located separate from the social expression products, and may comprise art, themes, or characteristics intended to enhance the thought of the social expression products. Further, the physical lottery tickets and/or gift cards may be positioned adjacent to a social expression product display in a retail location.

In an exemplary embodiment, the digital experience comprising a lottery ticket or gift card may be associated with a URL in a social expression product. This may be done by, for example, scanning the greeting card at the computing device 110 after purchasing the digital lottery ticket and/or digital gift card. Alternatively, the product could be purchased first and the URL within the greeting card could be provided by the purchaser at a website or retail location for purchasing lottery tickets or gift cards.

In another alternative embodiment, the digital experience may be provided by the computing device or retail store to be included with the greeting card and may be associated with or downloaded to a digital delivery device for supplementing the social expression product. Once the recipient receives the greeting card, she can insert the digital delivery device and/or access the URL to access the digital experience, which may comprise a digital lottery ticket and/or digital gift card. In an alternative embodiment, the recipient may go to a website where she can provide information for receiving a physical gift, such as an address where the conventional lottery tickets or gift cards may be sent.

In another exemplary embodiment, a card purchaser can be provided with the opportunity to combine a conventional greeting card with a gift certificate or gift card. In this exemplary embodiment, a card purchaser selects a conventional paper greeting card from the greeting card display. The purchaser may select any card from the display or the purchaser may be provided with visual cues directing the purchaser to cards that are coordinated with or best suited to be combined with gift cards and certificates. The purchaser can scan the greeting card's bar code at the computing device 110. The purchaser can select a gift card from options provided at the computing device 110 in a manner similar to that described above with regard to digital delivery devices, digital experiences, or lottery tickets. A gift card may be selected based on the store that the gift card can be used at, the value of the supplemental medium, or both. Once the gift card and amount have been selected, the purchaser can swipe a credit, debit, gift, or charge card through a magnetic stripe reader that may be included in the computing device 110 for performing purchases. The computing device 110 may also be able to apply art or characteristics in common with the greeting card onto at least a portion of the supplemental medium that can be purchased at the computing device 110. For instance, the computing device 110 may determine the art of the gift card to be purchased when the greeting card purchaser scans the bar code of the greeting card and then applies art related to the greeting card to the gift card that has been purchased. The computing device 110 can then dispense the gift card purchased by the card purchaser.

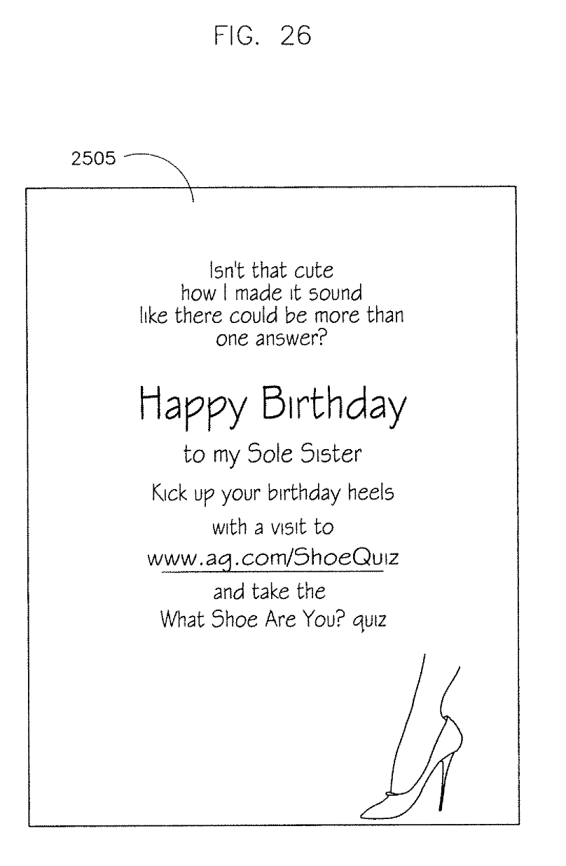

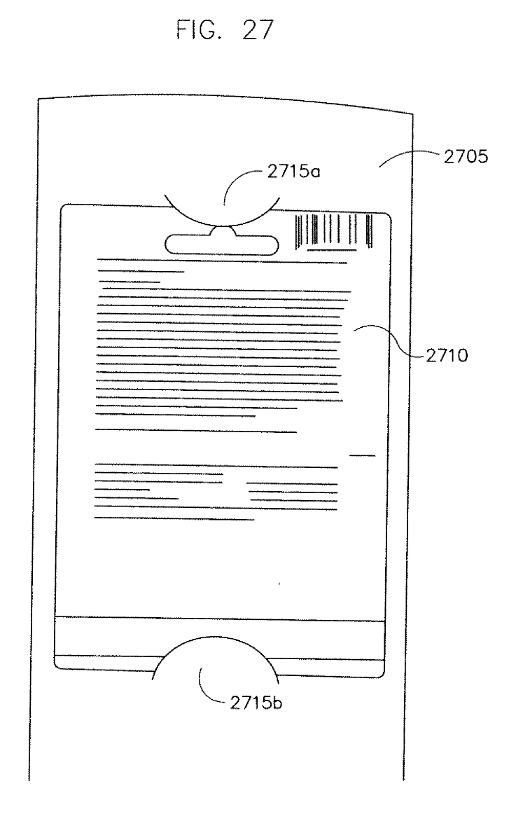

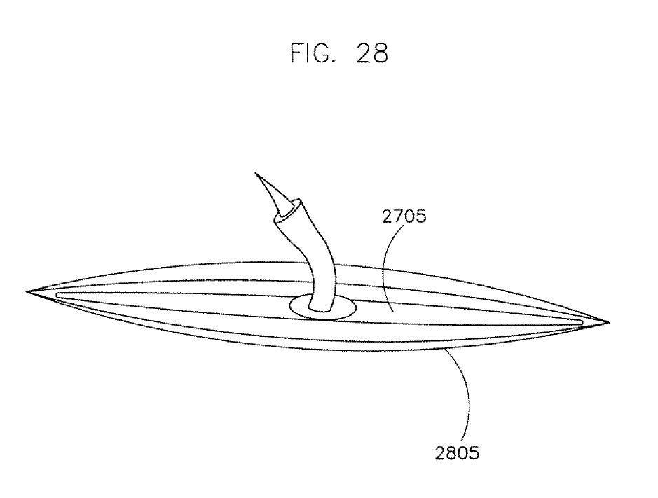

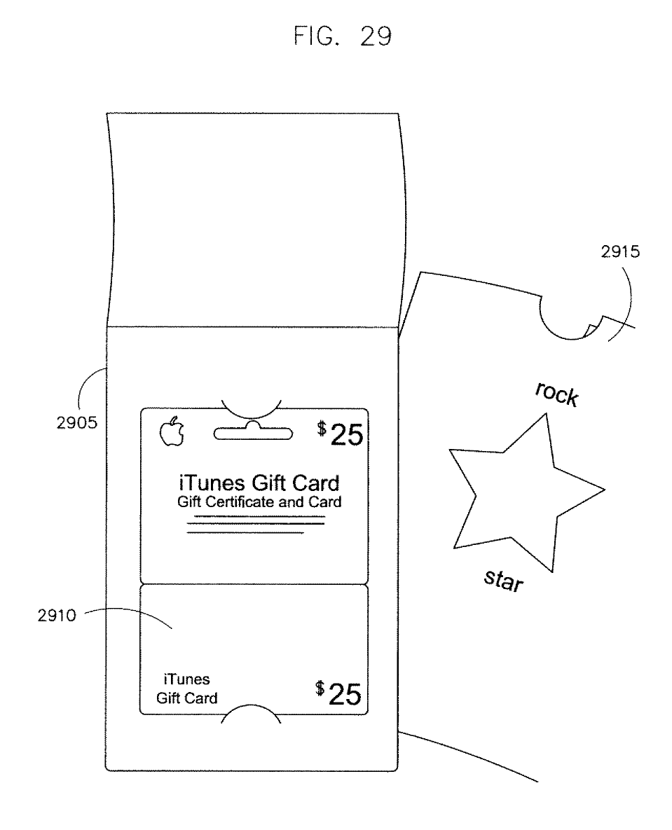

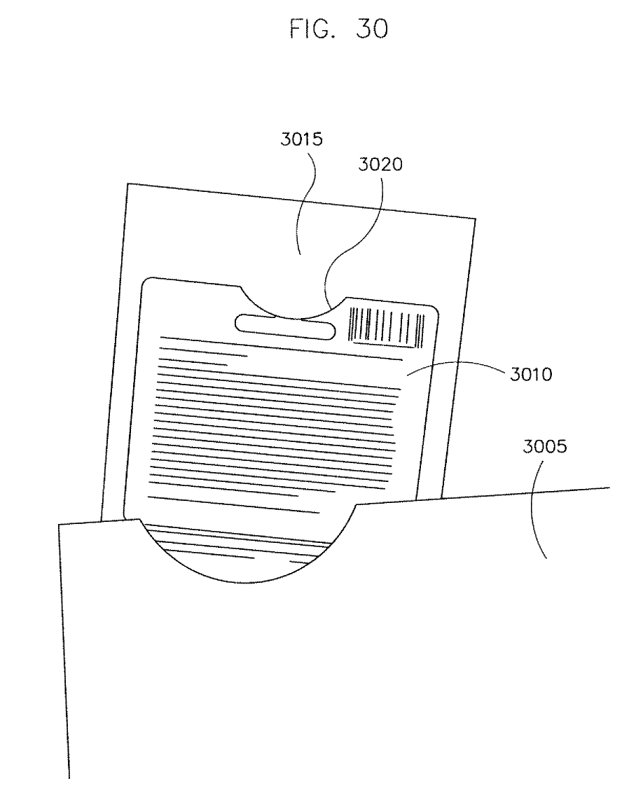

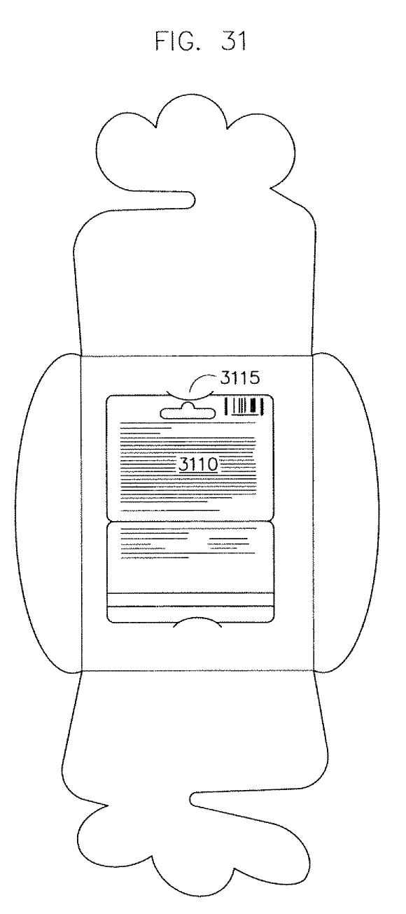

In an exemplary embodiment, the gift card may be placed within a place holder and/or behind a reveal designed for the medium within the greeting card. The purchaser may place the gift card in the greeting card or the greeting card may be pre-packaged with the gift card in place. FIGS. 27-31 illustrate exemplary embodiments for affixing a gift card to a greeting card. As illustrated in FIG. 27, a gift card 2710 is affixed to a greeting card reveal 2705 by slits 2715a-b. In FIG. 28, a greeting card reveal 2705 may be inserted in a greeting card 2805 such that the gift card (not shown) is hidden within the greeting card. As illustrated, in FIG. 29, a gift card 2910 is included in a reveal 2905 that folds over to display a message and may be inserted into a hidden compartment (i.e., holder) 2915. In FIG. 30, a gift card 3010 is affixed to a reveal 3015 with slits 3020 and can be inserted into a greeting card 3005. And in FIG. 31, a gift card 3110 is affixed to a foldable greeting card 3105 with slits 3115.

In a related exemplary embodiment, for gift cards to “online” stores and conventional stores with online websites for ordering or purchasing items, the purchaser can select a gift card for purchase. The information related to the gift card can be stored on a digital delivery device, such as a flash drive or flash memory card with USB connectivity. The computing device 110 can then dispense the digital delivery device for inclusion with the greeting card in a place-holder or behind a reveal. Alternatively, the digital delivery device may be included with the greeting card and, upon selection of the gift certificate and payment, the digital delivery device may be connected to the computing device 110 and the information can be downloaded to the digital delivery device for inclusion with the greeting card. Further, a digital delivery device with pre-loaded digital gift cards may be selected for inclusion with a greeting card. In any of these cases, however, the digital delivery device may be affixed or secured to the greeting card as illustrated in FIGS. 13-22.

In yet another exemplary embodiment of the present invention, either in combination with those embodiments described hereinabove or standing alone, lottery tickets and/or gift cards may be provided that are closely related or tied to social expression products without having to use the computing device 110. For example, a design theme for a lottery ticket, gift card, and greeting card may be coordinated to provide a total gift solution. Specifically, the art, theme, or other copy-related characteristics on the lottery ticket or gift card can be coordinated with (or identical to) the art, theme, or other copy-related characteristics for the greeting card, gift packaging, or other social expression product. In the alternative, the art for the greeting cards or gift packaging can be coordinated with lottery tickets or gift cards that are available for purchase in the same manner. For example, the message in the scratch-off portion of the lottery ticket may correspond to the internal copy of the greeting card. This message may be in the coated portion of the lottery ticket that is subsequently scratched off or the message may be inserted into the permanent portion of the lottery ticket under the scratch-off coating.

The messages or gifts provided by the lottery tickets or gift cards may enhance the thought of the greeting card (e.g., the lottery ticket or greeting card may answer a question posed within the greeting card or may be tied to the greeting card in other similar ways known to those of ordinary skill in the art). Further, the portions of a lottery ticket or gift card that are not scratched off, or the gift cards and lottery tickets that do not include a scratch-off game, may include a message that enhances the thought of the greeting card.

As discussed with reference to FIGS. 27-31, the format of the greeting card may also be designed to physically deliver a lottery ticket and/or gift card, or the greeting card format can be modified to better suit the inclusion of lottery tickets and gift cards therein. For example, the greeting card may be specifically designed to include therein a lottery ticket or gift card holder. In exemplary embodiments, the greeting card may be provided with product reveals within the internal or external portion of the greeting card that do not disrupt the sentiment provided by the art and copy of the greeting card (see FIGS. 27-30). These reveals can provide an opportunity for the greeting card recipient to discover the lottery ticket or gift card by peeling back layers of the internal portion of the greeting card, revealing a hidden compartment within the greeting card, or providing a place-holder within the greeting card that incorporates the lottery ticket or gift card into the overall look and feel of the card.

In yet another example, the size and/or shape of the lottery tickets or gift cards can be modified to reflect the value of the ticket or gift. For instance, as the value of the tickets or gift cards increases, based on either the purchase price or the maximum prize value, the size of the ticket or card can be correspondingly increased. Alternatively, lottery tickets or gift cards having different price points or payout levels may be created in different shapes. In addition, greeting cards can be created that include reveals or place holders that correspond to the differing sizes and/or shapes of the lottery tickets and gift cards, such that certain of the tickets or gift cards may only fit in a specific subset of greeting cards.

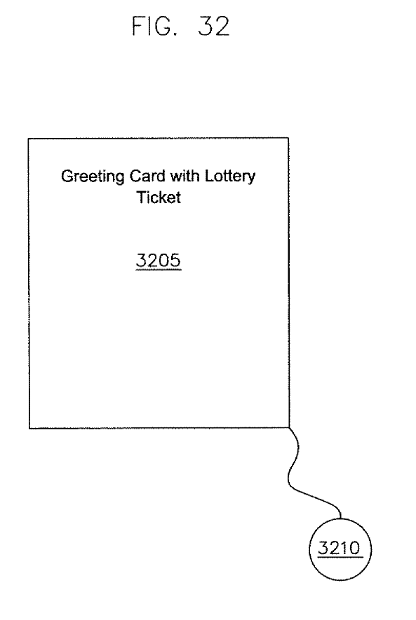

In another exemplary embodiment of the present invention, as illustrated in FIG. 32, a social expression product 3205 may include a scratching apparatus 3210 attached or affixed to it. The scratching apparatus may be used in conjunction with the lottery tickets which may be included therein to scratch off the scratch-off portion of the lottery ticket. The scratching apparatus may be removably affixed to the social expression product through the use of an adhesive, may be affixed to the social expression product by way of a string or ribbon, may be held in place by a place-holder within the social expression product, or may be included with the social expression product in many other ways known to those of ordinary skill in the art.

In another alternative exemplary embodiment of the present invention, a social expression product purchaser could access a website and order a paper social expression product and one or more lottery tickets, gift cards, or digital delivery devices to enhance the thought of the social expression product. The purchaser can be provided with the opportunity to personalize the paper social expression product via the website. The paper social expression product could then be printed remotely from the location of the purchaser. The personalized paper social expression product can then be sent to the card recipient with a lottery ticket, gift card, or digital delivery device placed with the greeting card. In addition or alternatively, the social expression product may include a URL for accessing a digital experience to enhance the thought of the social expression product.

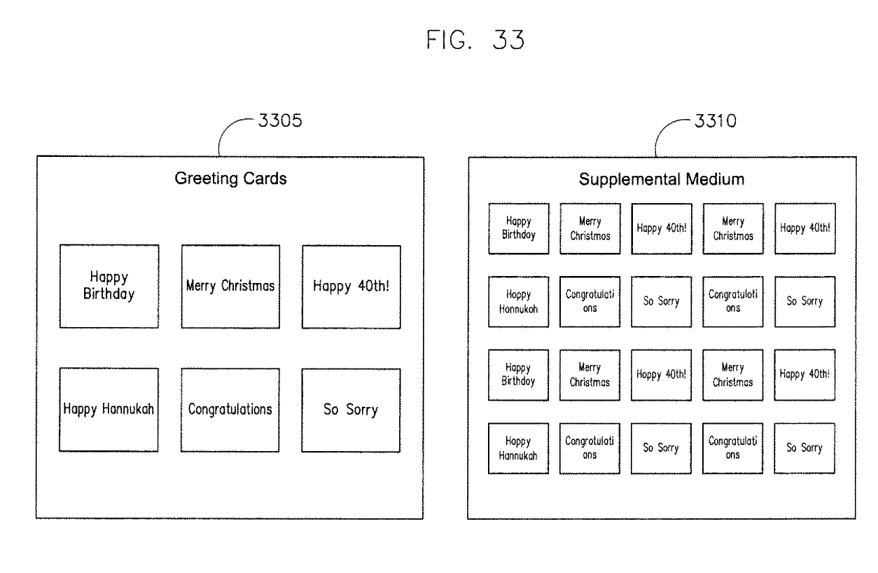

In another exemplary embodiment of the present invention illustrated in FIG. 33, a method and apparatus for providing greeting cards with any of the supplemental mediums (e.g., gift cards, lottery tickets, digital delivery devices) is described. As illustrated, a greeting card display 3305 holding a small portion of the normal display of greeting cards may be provided adjacent to, alongside, or upon a counter, register, or display 3310 where the supplemental mediums may be purchased. For example, a greeting card display 3310 holding six card styles specifically designed to be incorporated with lottery tickets and/or gift cards can be positioned along the counter or near the check-out register where lottery tickets and/or gift cards are generally purchased within a store (for example a convenience store or grocery store). The presentation of the greeting cards near the purchase area for the lottery tickets and/or gift cards is intended to promote an impulse buy of the greeting cards to be combined with the lottery ticket or gift card. In the alternative, the greeting card display 3310 may be positioned adjacent the lottery ticket generator, or an electronic marquee for the lottery ticket generator, so that when the purchaser's eye is attracted to the scrolling message of the electronic marquee, the greeting card display will also be within the purchaser's field of vision. The store may or may not include a separate area where greeting cards are typically purchased therein.

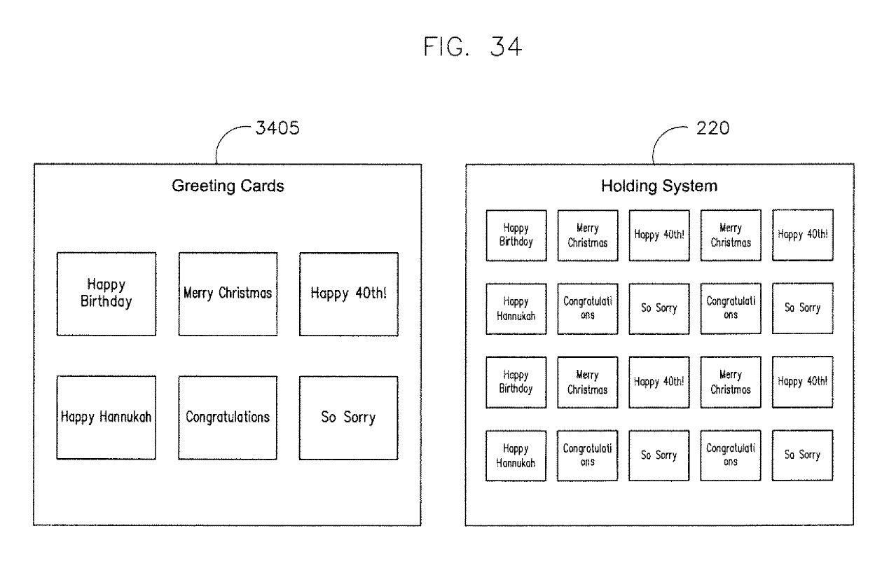

Alternatively, as illustrated in FIG. 34 (and referring to FIG. 2), for supplemental mediums that can be purchased using the holding system 220, which may include the use of a vending machine, a greeting card display 3405 may be positioned adjacent to the holding system 220. The card display 3405 will generally include a small portion of what a normal display of greeting cards would typically include. The cards within the display adjacent the vending machine will generally be directed to the inclusion of or coordinated with the supplemental mediums that can be purchased from the holding system 220. The placement of the greeting cards adjacent to the vending machine is intended to generate an impulse purchase of the greeting card to be combined with a digital delivery device, lottery ticket, or gift card.

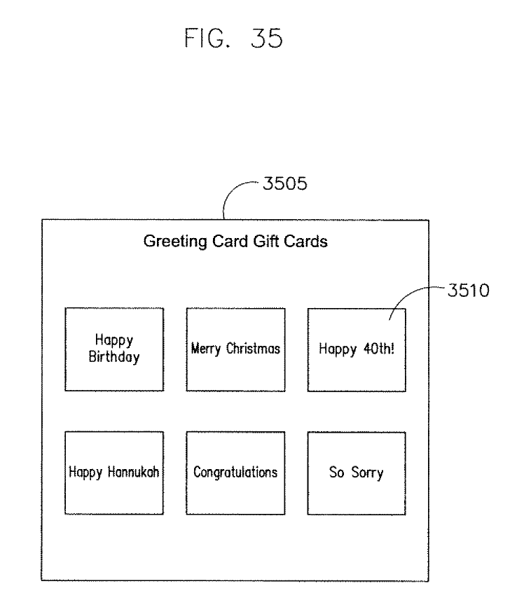

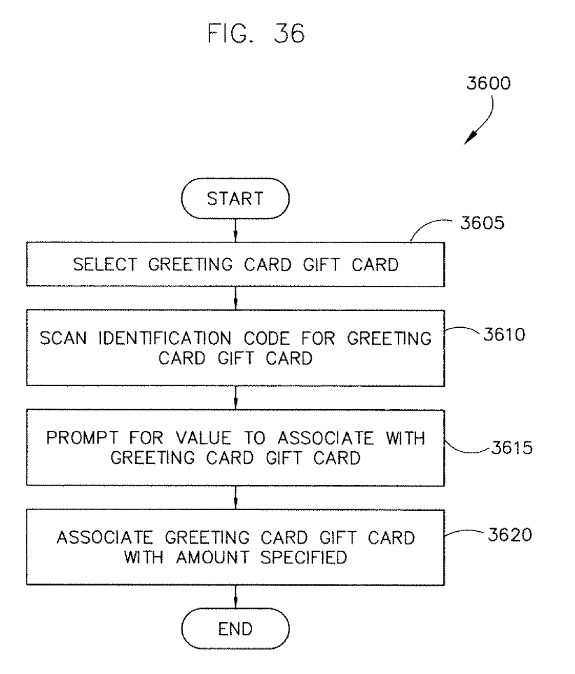

In another exemplary embodiment of the present invention, illustrated in FIG. 35, a greeting card purchaser can enter upon a section in a retail store 105 that includes a combined greeting card and gift card 3510 (herein referred to as a “greeting card gift card”). The greeting card gift card 3510 comprises a combination greeting card and gift card that is sold as a single unit (i.e., the greeting card physically comprises the gift card). FIG. 36 illustrates an exemplary method for utilizing a greeting card gift card 3510. The process begins at the START step and continues to step 3605, where a purchaser selects a greeting card gift card from the display and presents it at the register or check-out area for payment. In step 3610, the employee at the register scans the bar code of the greeting card gift card and is prompted, in step 3615, to ask the purchaser how much value they would like to place on the gift card. The purchaser provides the value amount and the employee enters that amount, which is associated with the gift card in step 3620. The employee totals the amount of the greeting card gift card unit and the purchaser pays the total amount and the process continues to the END step. Alternatively, instead of being performed by an employee at a register, the process above may be performed by the purchaser at the computing device 110, a self-pay teller, or other self-pay type device located within the retail location (or thereafter using a website designed to add value to the greeting card gift card).

In yet another exemplary embodiment of the present invention, supplemental mediums may be combined with social expression products and/or provided in a multi-pack format. In this way, for example, the social expression product and supplemental medium may be incorporated as all or a portion of the gifts in an exchange game, such as a “white elephant” exchange. In this game, a group of people gather and open gifts in a sequential order. The gifts may be handed out prior to beginning the gift-opening process or the gifts may be pooled and selected by each person immediately prior to opening her gift. When it is time for a person to open her gift she has the option of selecting a gift from the pile or taking one from a person who has already opened their gift. In the event that the supplemental medium is a lottery ticket, and the lottery ticket is of a scratch-off variety, the tickets are generally not scratched until all of the gifts have been distributed, opened and the exchanges completed; however the game can be modified to have each person scratch off their ticket when they open their gift. In another alternative to the game format, the supplemental medium that is included with the greeting card can include numbers that need to be matched in a drawing to determine the winner. In this version of the game, the drawing to determine the lottery winner would typically occur after all of the gifts have been distributed and opened, and the exchanges completed.

In conclusion, the present invention supports methods and systems for supplying supplemental content for a greeting card. In addition, the present invention supports methods and systems for supplying a supplemental medium with a greeting card. Furthermore, the present invention supports methods and systems for tying together greeting cards and lottery tickets through the use of themes, copy, art, and/or design specifically intended for the combination of digital delivery devices, lottery tickets, and/or greeting cards. In addition, the present invention supports methods and apparatus for marketing greeting cards adjacent to purchase points for supplemental mediums, such as lottery tickets and gift cards. Furthermore, the present invention supports methods for remotely purchasing a conventional greeting card and supplemental medium, personalizing the greeting card and having the card and greeting card and supplemental medium placed together and sent to a card recipient. In addition, the present invention supports methods and apparatus for purchasing a greeting card and supplemental medium at a retail outlet and applying the art of the greeting card to the supplemental medium based on an evaluation of the greeting card. The present invention also supports methods and apparatus for purchasing a combined greeting card and gift card and selecting the amount of the gift card after selection of the combined entity. It will be appreciated that the present invention fulfills the needs of the prior art. While there have been shown and described several exemplary embodiments of the present invention, it will be evident to those of ordinary skill in the art that various modifications and changes may be made thereto without departing from the spirit and the scope of the present invention as set forth herein.

We claim the following:

1. A social expression product, comprising:
a memory storage device comprising a digital experience defined by computer-readable content corresponding to a theme of the social expression product and a housing with a configuration having a visible appearance corresponding to the theme; and
a greeting card comprising:
a first panel connected by a card fold to a second panel, each panel displaying printed content associated with the theme of the social expression product; and
a structure for holding the memory storage device with the greeting card, the structure comprising at least a portion of transparent material and affixed to one of the panels of the greeting card in a manner that permits viewing at least a portion of the memory storage device from an exterior view of the greeting card.

2. The social expression product of claim 1, wherein the structure is configured to allow removal of the memory storage device from the greeting card for connection to a computing device and access to the computer-readable content of the digital experience.

3. The social expression product of claim 1, wherein the memory storage device comprises a Universal Serial Bus (“USB”) flash drive.

4. The social expression product of claim 1, wherein the digital experience comprises one of music, a game, an avatar, a message, a photo, a video, a screen saver, and an animation.

5. A social expression product, comprising:
a Universal Serial Bus (“USB”) flash drive storing computer-readable content corresponding to a theme of the social expression product; and
a greeting card displaying printed content associated with the theme of the social expression product, the greeting card comprising a structure having a molded housing configured for holding the USB flash drive with the greeting card in a manner that permits viewing at least a portion of the USB flash drive from an exterior view of the greeting card.

6. The social expression product of claim 5, wherein the molded housing is further configured to allow for removal of the USB flash drive from the greeting card to permit operation of the USB flash drive with a computing device.

7. The social expression product of claim 5, wherein the greeting card further comprises a first panel joined by card fold to a second panel and the structure is affixed to one of the panels in a manner that permits viewing at least a portion of the structure from an exterior view of the card.

8. The social expression product of claim 5, wherein the USB flash drive comprises a housing with an exterior configuration corresponding to one of shape, size, color, or form for the theme of the social expression product.

9. A social expression product, comprising:
a Universal Serial Bus (“USB”) flash drive storing computer-readable content corresponding to a theme of the social expression product, the USB flash drive having an external configuration with a visible appearance that is consistent with the theme; and
a greeting card comprising:
a first panel connected by a card fold to a second panel, each panel displaying printed content associated with the theme of the social expression product; and
a molded structure for holding the USB flash drive with the greeting card in a position for viewing at least a portion of the USB flash drive through an opening in the first panel of the greeting card.

10. The social expression product of claim 9, wherein the molded structure is affixed to one of the panels and visible from an exterior view of the greeting card.

11. The social expression product of claim 9, wherein the computer-readable content comprises multi-media content designed to enhance an expression of the theme presented by the printed content.
